(19) United States
(12) Patent Application Publication
(10) Pub. No.: US 2026/0265143 A1
(43) Pub. Date: Sep. 10, 2026

(54) CEMENT SACK COMPOSITIONS AND METHODS FOR MAKING AND USING THE SAME

(71) Applicant: Saudi Arabian Oil Company, Dhahran (SA)

(72) Inventor: Joseph M. Shine, JR., Houston, TX (US)

(21) Appl. No.: 19/071,120

(22) Filed: Mar. 5, 2025

(51) Int. Cl. C04B 28/04; C04B 7/02; C04B 14/28; C09K 8/46

(52) U.S. Cl. CPC C04B 28/04; C04B 7/02; C04B 14/285; C09K 8/46; C04B 2201/50

(57) ABSTRACT

The invention provides a cement sack composition. The cement sack composition includes a hydraulic cement selected from the group consisting of an API Class A Portland cement, an API Class C Portland cement, an API Class G Portland cement, an API Class H Portland cement, and combinations thereof; and an additive in an amount of about 0.01 to about 50% by weight substitution of the hydraulic cement in the cement sack composition. The additive is selected from fine grade marble, medium grade marble, coarse grade marble, and combinations thereof.

### STATEMENT OF PRIOR DISCLOSURE BY THE INVENTOR

Aspects of the present disclosure are described in Shine, J. M., Hassan, Y. A., and I. Gbemiga. “A Study of Cement Substitution: Demonstrating Suitable Performance Helping to Reduce the CO₂ Footprint.” Paper presented at the SPE Annual Technical Conference and Exhibition, New Orleans, Louisiana, USA, Sep. 20, 2024, incorporated herein by reference in its entirety.

### TECHNICAL FIELD

The present disclosure relates to cement sack compositions, more particularly, to cement sack substitution using calcium magnesium carbonate, such as dolomite and/or marble, to reduce carbon dioxide emissions in well construction operations. The present disclosure also relates to methods of producing a cured specimen and methods of cementing oil and gas wells.

### BACKGROUND

A current sack of API Portland cement is composed entirely of neat (e.g., 100%) cement and plays a critical role in various oil and gas operations, including wellbore integrity, zonal isolation, and casing support.

However, the production of Portland cement is a significant source of greenhouse gas emissions, primarily carbon dioxide (CO₂). These emissions stem from two main sources: (i) the combustion of fossil fuels required to heat raw materials to extreme temperatures during the clinker production process, and (ii) the chemical reaction of limestone (calcium carbonate) decomposition, which releases CO₂ as a byproduct. As a result, cement manufacturing is a contributor to global industrial CO₂ emissions, posing environmental challenges related to climate change and sustainability.

### SUMMARY

Described herein are technologies related to cement sack compositions designed to create an equivalent sack of cement for the same oil and gas applications. This disclosure also describes technologies relating to methods of producing a cured specimen from the cement sack compositions and methods of cementing oil and gas wells.

### BRIEF DESCRIPTION OF DRAWINGS

FIG. 1A illustrates fine grade marble (marble of fine particles), according to certain embodiments of the present disclosure.

FIG. 1B illustrates medium grade marble (marble of medium particles), according to certain embodiments of the present disclosure.

FIG. 1C illustrates coarse grade marble (marble of coarse particles), according to certain embodiments of the present disclosure.

FIG. 2 is a flow chart depicting a method of producing a cured specimen, according to certain embodiments of the present disclosure.

FIG. 3 is a flow chart depicting a method of cementing oil and gas wells, according to certain embodiments of the present disclosure.

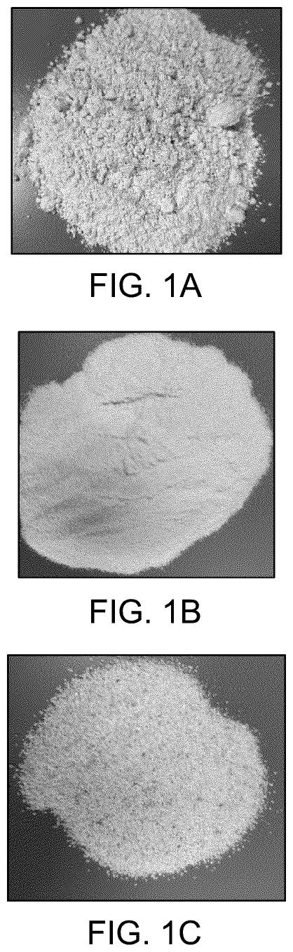

### DETAILED DESCRIPTION

A neat API oil well cement sack must meet minimum performance specifications, serving as an industry standard for oil and gas operations. The present disclosure introduces an equivalent cement sack that utilizes mined materials, such as marble and/or dolomite, as partial substitutes for traditional oil well cement while maintaining comparable performance. By incorporating a controlled degree of substitution, cement sack compositions of the present disclosure reduce the amount of neat cement required, thereby lowering annual CO₂ emissions. This innovation provides the industry with a sustainable alternative that minimizes environmental impact without compromising the performance and reliability required for oil and gas applications.

The substitution ratio or percentage ranges from, e.g., 0.01% to 50%, of marble prepared through either a post-blend or interblended method at the manufacturing stage. In the post-blend method, neat API cement is combined with the required percentage of marble to achieve a total weight equivalent to a full cement sack (e.g., a 20% marble substitution requires 80% API cement). The interblended method, on the other hand, involves incorporating marble directly into the API cement at the manufacturing plant at the designated substitution percentage before delivery to the end user as an equivalent sack. Regardless of the technique used, the reduction in API cement consumption can directly decrease greenhouse gas emissions.

These compositions incorporate mined materials as partial substitutes for traditional oil well cement, achieving a degree of substitution that maintains or enhances performance while meeting the same industry standards as 100% neat oil well cement. By optimizing the formulation, the cement sack compositions of the present disclosure aim to improve sustainability, reduce greenhouse gas emissions, and maintain the necessary mechanical properties, durability, and resistance required for demanding downhole conditions.

Marble, commonly referred to as dolomitic limestone (e.g., dolomite), consists of, e.g., 80% to 99% dolomite, with the remaining composition consisting of limestone, calcite, and other inert impurities (e.g., less than 1% to 20%), as confirmed by X-ray diffraction (XRD) analysis. The marble particles have a 50% cumulative particle size (D₅₀) of, e.g., from 10 to 600 micrometers (μm), a 90% cumulative particle size (D₉₀) of, e.g., from 40 to 1000 μm, and a surface area of, e.g., from 40 to 1000 square meters per kilogram (m²/kg). The specific gravity of marble varies between, e.g., 2.4 and 3.0. As dolomite is chemically inert to cement during hydration, it serves as a suitable substitute material, also contributing to a lower heat of hydration.

To ensure performance equivalency, the chemistry of the substituted cement sack is tested using X-ray fluorescence (XRF) analysis to confirm that pre-hydrated (dry) cement meets API Specification 10A-2019 (Cements and Materials for Well Cementing, American Petroleum Institute (API) (i.e., API Specification 10A), 2019, which is incorporated herein by reference in its entirety). While no API standards exist for post-hydrated (wet) cement, the equivalent sack exhibits comparable chemical and physical properties to traditional API cement. Performance comparisons demonstrate that the substitution maintains or exceeds similar strength, durability, and operational functionality.

Additionally, the incorporation of dolomitic limestone enhances the resistance of the cement to corrosive fluids. By reducing the concentration of portlandite—an inherently reactive compound found in API cement—the equivalent sack exhibits improved corrosion resistance, making it a more environmentally sustainable solution for oil and gas applications.

Provided in the present disclosure are cement sack compositions as an equivalent cement sack for neat oil well cement. The cement sack composition includes a hydraulic cement selected from the group consisting of an API Class A Portland cement, an API Class C Portland cement, an API Class G Portland cement, an API Class H Portland cement, and combinations thereof. In some embodiments, the cement sack composition includes an API Class A Portland cement. In some embodiments, the cement sack composition includes an API Class C Portland cement. In some embodiments, the cement sack composition includes an API Class G Portland cement. In some embodiments, the cement sack composition includes an API Class H Portland cement.

In some embodiments, the hydraulic cement in the cement sack composition of the present disclosure further includes Saudi Class G hydraulic cement, Portland fly ash cement, Portland Pozzolan cement, Portland silica fume cement, masonry cements, mortars, EMC cements, stuccos, plastic cements, expansive cements, white blended cements, Pozzolan-lime cements, slag-lime cements, supersulfated cements, calcium aluminate cements, calcium sulfoaluminate cements, geopolymer cements, Rosendale cements, polymer cement mortar, lime mortar, and/or pozzolana mortar. In one embodiment, the hydraulic cement comprises a cement blend of two or more types of cement, for example, a blend comprising Portland cement and non-Portland hydraulic cement. In a further embodiment, the cement is in the dry form. In one embodiment, the hydraulic cement is selected from the group consisting of an API Class A Portland cement, an API Class C Portland cement, an API Class G Portland cement, an API Class H Portland cement, and a Saudi Class G hydraulic cement.

Typically, hydraulic cements, particularly Portland cements, are used to cement the well casing within the well bore. Hydraulic cements set and develop compressive strength due to the occurrence of a hydration reaction which allows them to set or cure under subterranean conditions. The physical properties of the set cement relate to the crystalline structure of the calcium-silicate-hydrates formed during hydration. For example, conventional Portland cements form an interlocking crystalline network of, for example, tricalcium silicate, dicalcium silicate, tetracalcium aluminum ferrite and calcium hydroxide crystals. These crystals interconnect to form an interlocking crystalline structure which provides both flexural strength and a degree of resiliency. Hydration products of Portland cements may also form crystalline or amorphous interlocking networks of the hydration products calcium silicate hydrate (CSH, or C—S—H), calcium hydroxide (CH, or Portlandite), other calcium silicates, aluminum calcium iron oxide (such as Ca₂FeAlO₅), and/or silicon dioxide.

In some embodiments, the hydraulic cement is present in the cement sack composition in an amount of about 50 to about 99.99% by weight of the cement sack composition, such as about 55 to about 95%, about 60 to about 90%, about 65 to about 85%, about 70 to about 80%, or about 52%, about 54%, about 56%, about 58%, about 60%, about 62%, about 64%, about 66%, about 68%, about 70%, about 72%, about 74%, about 76%, about 78%, about 80%, about 82%, about 84%, about 86%, about 88%, about 90%, about 92%, about 94%, about 96%, or about 98% by weight of the cement sack composition. In some embodiments, the hydraulic cement is present in the cement sack composition in an amount of about 65 to about 95% by weight of the cement sack composition.

In some embodiments, the hydraulic cement is an API Class A Portland cement. In some embodiments, the API Class A Portland cement is present in the cement sack composition in an amount of about 50 to about 99.99% by weight of the cement sack composition, such as about 55 to about 95%, about 60 to about 90%, about 65 to about 85%, about 70 to about 80%, or about 52%, about 54%, about 56%, about 58%, about 60%, about 62%, about 64%, about 66%, about 68%, about 70%, about 72%, about 74%, about 76%, about 78%, about 80%, about 82%, about 84%, about 86%, about 88%, about 90%, about 92%, about 94%, about 96%, or about 98% by weight of the cement sack composition. In some embodiments, the API Class A Portland cement is present in the cement sack composition in an amount of about 65 to about 95% by weight of the cement sack composition.

In some embodiments, the hydraulic cement is an API Class C Portland cement. In some embodiments, the API Class C Portland cement is present in the cement sack composition in an amount of about 50 to about 99.99% by weight of the cement sack composition, such as about 55 to about 95%, about 60 to about 90%, about 65 to about 85%, about 70 to about 80%, or about 52%, about 54%, about 56%, about 58%, about 60%, about 62%, about 64%, about 66%, about 68%, about 70%, about 72%, about 74%, about 76%, about 78%, about 80%, about 82%, about 84%, about 86%, about 88%, about 90%, about 92%, about 94%, about 96%, or about 98% by weight of the cement sack composition. In some embodiments, the API Class C Portland cement is present in the cement sack composition in an amount of about 65 to about 95% by weight of the cement sack composition.

In some embodiments, the hydraulic cement is an API Class G Portland cement. In some embodiments, the API Class G Portland cement is present in the cement sack composition in an amount of about 50 to about 99.99% by weight of the cement sack composition, such as about 55 to about 95%, about 60 to about 90%, about 65 to about 85%, about 70 to about 80%, or about 52%, about 54%, about 56%, about 58%, about 60%, about 62%, about 64%, about 66%, about 68%, about 70%, about 72%, about 74%, about 76%, about 78%, about 80%, about 82%, about 84%, about 86%, about 88%, about 90%, about 92%, about 94%, about 96%, or about 98% by weight of the cement sack composition. In some embodiments, the API Class G Portland cement is present in the cement sack composition in an amount of about 65 to about 95% by weight of the cement sack composition.

In some embodiments, the hydraulic cement is an API Class H Portland cement. In some embodiments, the API Class H Portland cement is present in the cement sack composition in an amount of about 50 to about 99.99% by weight of the cement sack composition, such as about 55 to about 95%, about 60 to about 90%, about 65 to about 85%, about 70 to about 80%, or about 52%, about 54%, about 56%, about 58%, about 60%, about 62%, about 64%, about 66%, about 68%, about 70%, about 72%, about 74%, about 76%, about 78%, about 80%, about 82%, about 84%, about 86%, about 88%, about 90%, about 92%, about 94%, about 96%, or about 98% by weight of the cement sack composition. In some embodiments, the API Class H Portland cement is present in the cement sack composition in an amount of about 65 to about 95% by weight of the cement sack composition.

In some embodiments, the hydraulic cement has a composition by weight relative to the total weight of the hydraulic cement of about 1.7-2.1% magnesium oxide (MgO), about 1.5-2.3% aluminum oxide (Al₂O₃), about 17-21% silicon dioxide (SiO₂), about 2-2.4% sulfur trioxide (SO₃), 0.1-0.8% about sodium oxide (Na₂O), 65-77% about calcium oxide (CaO), about 4.5-7% iron(III) oxide (Fe₂O₃), about 0-3% calcium carbonate (CaCO₃), about 47-51% tricalcium silicate (C₃S), about 17-20% dicalcium silicate (C₂S), about 0.2-1.5% tricalcium aluminate (C₃A), about 14-18% tetracalcium aluminoferrite (C₄AF), about 16-19% tetracalcium aluminoferrite and tricalcium aluminate (C₄AF+2C₃A), about 0.5-4% ignition loss (LOI), and about 0.3-1% insoluble residue. In some embodiments, the hydraulic cement is a medium sulfate-resistant (MSR) grade cement having about 6 to 10% C₃A, such as about 6.5 to about 9.5%, about 7 to about 9%, or about 8% C₃A. In some embodiments, the MSR grade hydraulic cement has a C₃A content of about 8% C₃A. In some embodiments, the hydraulic cement is a high sulfate-resistant (HSR) grade cement having about 1 to 5% C₃A, such as about 1.5 to about 4.5%, about 2 to about 4%, or about 3% C₃A. In some embodiments, the HSR grade hydraulic cement has a C₃A content of about 3% C₃A.

In some embodiments, the cement sack composition includes an additive in an amount of about 0.01 to about 50% by weight substitution of the hydraulic cement in the cement sack composition, such as about 0.5 to about 49%, about 1 to about 48%, about 2 to about 47%, about 3 to about 46%, about 4 to about 45%, about 5 to about 44%, about 6 to about 43%, about 7 to about 42%, about 8 to about 41%, about 9 to about 40%, about 10 to about 39%, about 11 to about 38%, about 12 to about 37%, about 13 to about 36%, about 14 to about 35%, about 15 to about 34%, about 16 to about 33%, about 17 to about 32%, about 18 to about 31%, about 19 to about 30%, about 20 to about 29%, about 21 to about 28%, about 22 to about 27%, about 23 to about 26%, about 24 to about 25%, or about 0.01%, about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, about 14.5%, about 15.5%, about 16.5%, about 17.5%, about 18.5%, about 19.5%, about 20.5%, about 21.5%, about 22.5%, about 23.5%, about 24.5%, about 25.5%, about 26.5%, about 27.5%, about 28.5%, about 29.5%, about 30.5%, about 31.5%, about 32.5%, about 33.5%, about 34.5%, about 35.5%, about 36.5%, about 37.5%, about 38.5%, about 39.5%, about 40.5%, about 41.5%, about 42.5%, about 43.5%, about 44.5%, about 45.5%, about 46.5%, about 47.5%, about 48.5%, about 49.5%, or about 50% by weight substitution of the hydraulic cement.

In some embodiments, the additive is selected from the group consisting of fine grade marble, medium grade marble, coarse grade marble, and combinations thereof. In some embodiments, the additive is fine grade marble. In some embodiments, the additive is medium grade marble. In some embodiments, the additive is coarse grade marble.

In some embodiments, the additive is fine grade marble. In some embodiments, the fine grade marble is present in the cement sack composition in an amount of about 0.01 to about 50% by weight substitution of the hydraulic cement in the cement sack composition, such as about 0.5 to about 49%, about 1 to about 48%, about 2 to about 47%, about 3 to about 46%, about 4 to about 45%, about 5 to about 44%, about 6 to about 43%, about 7 to about 42%, about 8 to about 41%, about 9 to about 40%, about 10 to about 39%, about 11 to about 38%, about 12 to about 37%, about 13 to about 36%, about 14 to about 35%, about 15 to about 34%, about 16 to about 33%, about 17 to about 32%, about 18 to about 31%, about 19 to about 30%, about 20 to about 29%, about 21 to about 28%, about 22 to about 27%, about 23 to about 26%, about 24 to about 25%, or about 0.01%, about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, about 14.5%, about 15.5%, about 16.5%, about 17.5%, about 18.5%, about 19.5%, about 20.5%, about 21.5%, about 22.5%, about 23.5%, about 24.5%, about 25.5%, about 26.5%, about 27.5%, about 28.5%, about 29.5%, about 30.5%, about 31.5%, about 32.5%, about 33.5%, about 34.5%, about 35.5%, about 36.5%, about 37.5%, about 38.5%, about 39.5%, about 40.5%, about 41.5%, about 42.5%, about 43.5%, about 44.5%, about 45.5%, about 46.5%, about 47.5%, about 48.5%, about 49.5%, or about 50% by weight substitution of the hydraulic cement.

In some embodiments, the additive is medium grade marble. In some embodiments, the medium grade marble is present in the cement sack composition in an amount of about 0.01 to about 50% by weight substitution of the hydraulic cement in the cement sack composition, such as about 0.5 to about 49%, about 1 to about 48%, about 2 to about 47%, about 3 to about 46%, about 4 to about 45%, about 5 to about 44%, about 6 to about 43%, about 7 to about 42%, about 8 to about 41%, about 9 to about 40%, about 10 to about 39%, about 11 to about 38%, about 12 to about 37%, about 13 to about 36%, about 14 to about 35%, about 15 to about 34%, about 16 to about 33%, about 17 to about 32%, about 18 to about 31%, about 19 to about 30%, about 20 to about 29%, about 21 to about 28%, about 22 to about 27%, about 23 to about 26%, about 24 to about 25%, or about 0.01%, about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, about 14.5%, about 15.5%, about 16.5%, about 17.5%, about 18.5%, about 19.5%, about 20.5%, about 21.5%, about 22.5%, about 23.5%, about 24.5%, about 25.5%, about 26.5%, about 27.5%, about 28.5%, about 29.5%, about 30.5%, about 31.5%, about 32.5%, about 33.5%, about 34.5%, about 35.5%, about 36.5%, about 37.5%, about 38.5%, about 39.5%, about 40.5%, about 41.5%, about 42.5%, about 43.5%, about 44.5%, about 45.5%, about 46.5%, about 47.5%, about 48.5%, about 49.5%, or about 50% by weight substitution of the hydraulic cement.

In some embodiments, the additive is coarse grade marble. In some embodiments, the coarse grade marble is present in the cement sack composition in an amount of about 0.01 to about 50% by weight substitution of the hydraulic cement in the cement sack composition, such as about 0.5 to about 49%, about 1 to about 48%, about 2 to about 47%, about 3 to about 46%, about 4 to about 45%, about 5 to about 44%, about 6 to about 43%, about 7 to about 42%, about 8 to about 41%, about 9 to about 40%, about 10 to about 39%, about 11 to about 38%, about 12 to about 37%, about 13 to about 36%, about 14 to about 35%, about 15 to about 34%, about 16 to about 33%, about 17 to about 32%, about 18 to about 31%, about 19 to about 30%, about 20 to about 29%, about 21 to about 28%, about 22 to about 27%, about 23 to about 26%, about 24 to about 25%, or about 0.01%, about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, about 14.5%, about 15.5%, about 16.5%, about 17.5%, about 18.5%, about 19.5%, about 20.5%, about 21.5%, about 22.5%, about 23.5%, about 24.5%, about 25.5%, about 26.5%, about 27.5%, about 28.5%, about 29.5%, about 30.5%, about 31.5%, about 32.5%, about 33.5%, about 34.5%, about 35.5%, about 36.5%, about 37.5%, about 38.5%, about 39.5%, about 40.5%, about 41.5%, about 42.5%, about 43.5%, about 44.5%, about 45.5%, about 46.5%, about 47.5%, about 48.5%, about 49.5%, or about 50% by weight substitution of the hydraulic cement.

In some embodiments, the fine grade marble is in the form of powders. In some embodiments, fine grade marble in the form of powders has a 10% cumulative particle size (D₁₀) of about 1 to about 5 micrometers (μm), such as about 1.5 to about 4.5 μm, about 2 to about 4 μm, about 2.5 to about 3.5 μm, or about 1.25 μm, about 1.5 μm, about 1.75 μm, about 2 μm, about 2.25 μm, about 2.5 μm, about 2.75 μm, about 3 μm, about 3.25 μm, about 3.5 μm, about 3.75 μm, about 4 μm, about 4.25 μm, about 4.5 μm, about 4.75 μm, or about 5 μm. In some embodiments, fine grade marble in the form of powders has a D₁₀ of about 2.75 μm.

In some embodiments, fine grade marble in the form of powders has a 50% cumulative particle size (D₅₀) of about 8 to about 32 μm, such as about 10 to about 30 μm, about 12 to about 28 μm, about 14 to about 26 μm, about 16 to about 24 μm, about 18 to about 22 μm, or about 8.5 μm, about 9.5 μm, about 10.5 μm, about 11.5 μm, about 12.5 μm, about 13.5 μm, about 14.5 μm, about 15.5 μm, about 16.5 μm, about 17.5 μm, about 18.5 μm, about 19.5 μm, about 20.5 μm, about 21.5 μm, about 22.5 μm, about 23.5 μm, about 24.5 μm, about 25.5 μm, about 26.5 μm, about 27.5 μm, about 28.5 μm, about 29.5 μm, about 30.5 μm, or about 31.5 μm. In some embodiments, fine grade marble in the form of powders has a D₅₀ of about 16.9 μm.

In some embodiments, fine grade marble in the form of powders has a 90% cumulative particle size (D₉₀) of about 32 to about 90 μm, such as about 34 to about 88 μm, about 36 to about 86 μm, about 38 to about 84 μm, about 40 to about 82 μm, about 42 to about 80 μm, about 44 to about 78 μm, about 46 to about 76 μm, about 48 to about 74 μm, about 50 to about 72 μm, about 52 to about 70 μm, about 54 to about 68 μm, about 56 to about 66 μm, about 58 to about 64 μm, about 60 to about 62 μm, or about 33 μm, about 36 μm, about 39 μm, about 42 μm, about 45 μm, about 48 μm, about 51 μm, about 54 μm, about 57 μm, about 60 μm, about 63 μm, about 66 μm, about 69 μm, about 72 μm, about 75 μm, about 78 μm, about 81 μm, about 84 μm, about 87 μm, or about 90 μm. In some embodiments, fine grade marble in the form of powders has a D₉₀ of about 61.5 μm.

In some embodiments, the medium grade marble is in the form of regular-shaped particles. In some embodiments, the medium grade marble in the form of regular-shaped particles has a D₁₀ particle size of about 5 to about 25 μm, such as about 6 to about 24 μm, about 7 to about 23 μm, about 8 to about 22 μm, about 9 to about 21 μm, about 10 to about 20 μm, about 11 to about 19 μm, about 12 to about 18 μm, about 13 to about 17 μm, about 14 to about 16 μm, about 15 to about 16 μm, or about 5.5 μm, about 6.5 μm, about 7.5 μm, about 8.5 μm, about 9.5 μm, about 10.5 μm, about 11.5 μm, about 12.5 μm, about 13.5 μm, about 14.5 μm, about 15.5 μm, about 16.5 μm, about 17.5 μm, about 18.5 μm, about 19.5 μm, about 20.5 μm, about 21.5 μm, about 22.5 μm, about 23.5 μm, or about 24.5 μm. In some embodiments, the medium grade marble in the form of regular-shaped particles has a D₁₀ particle size of about 11.4 μm.

In some embodiments, the medium grade marble in the form of regular-shaped particles has a D₅₀ particle size of about 100 to about 200 μm, such as about 105 to about 195 μm, about 110 to about 190 μm, about 115 to about 185 μm, about 120 to about 180 μm, about 125 to about 175 μm, about 130 to about 170 μm, about 135 to about 165 μm, about 140 to about 160 μm, about 145 to about 155 μm, or about 102 μm, about 104 μm, about 106 μm, about 108 μm, about 110 μm, about 112 μm, about 114 μm, about 116 μm, about 118 μm, about 120 μm, about 122 μm, about 124 μm, about 126 μm, about 128 μm, about 130 μm, about 132 μm, about 134 μm, about 136 μm, about 138 μm, about 140 μm, about 142 μm, about 144 μm, about 146 μm, about 148 μm, about 150 μm, about 152 μm, about 154 μm, about 156 μm, about 158 μm, about 160 μm, about 162 μm, about 164 μm, about 166 μm, about 168 μm, about 170 μm, about 172 μm, about 174 μm, about 176 μm, about 178 μm, about 180 μm, about 182 μm, about 184 μm, about 186 μm, about 188 μm, about 190 μm, about 192 μm, about 194 μm, about 196 μm, about 198 μm, about 200 μm. In some embodiments, the medium grade marble in the form of regular-shaped particles has a D₅₀ particle size of about 152 μm.

In some embodiments, the medium grade marble in the form of regular-shaped particles has a D₉₀ particle size of about 250 to about 410 μm, such as about 255 to about 405 μm, about 260 to about 400 μm, about 265 to about 395 μm, about 270 to about 390 μm, about 275 to about 385 μm, about 280 to about 380 μm, about 285 to about 375 μm, about 290 to about 370 μm, about 295 to about 365 μm, about 300 to about 360 μm, about 305 to about 355 μm, about 310 to about 350 μm, about 315 to about 345 μm, about 320 to about 340 μm, about 325 to about 335 μm, or about 254 μm, about 258 μm, about 262 μm, about 266 μm, about 270 μm, about 274 μm, about 278 μm, about 282 μm, about 286 μm, about 290 μm, about 294 μm, about 298 μm, about 302 μm, about 306 μm, about 310 μm, about 314 μm, about 318 μm, about 322 μm, about 326 μm, about 330 μm, about 334 μm, about 338 μm, about 342 μm, about 346 μm, about 350 μm, about 354 μm, about 358 μm, about 362 μm, about 366 μm, about 370 μm, about 374 μm, about 378 μm, about 382 μm, about 386 μm, about 390 μm, about 394 μm, about 398 μm, about 402 μm, about 406 μm, or about 410 μm. In some embodiments, the medium grade marble in the form of regular-shaped particles has a D₉₀ particle size of about 328 μm.

In some embodiments, the coarse grade marble is in the form of irregular-shaped particles. In some embodiments, the coarse grade marble in the form of irregular-shaped particles has a D₁₀ particle size of about 100 to about 300 μm, such as about 105 to about 295 μm, about 110 to about 290 μm, about 115 to about 285 μm, about 120 to about 280 μm, about 125 to about 275 μm, about 130 to about 270 μm, about 135 to about 265 μm, about 140 to about 260 μm, about 145 to about 255 μm, about 150 to about 250 μm, about 155 to about 245 μm, about 160 to about 240 μm, about 165 to about 235 μm, about 170 to about 230 μm, about 175 to about 225 μm, about 180 to about 220 μm, about 185 to about 215 μm, about 190 to about 210 μm, about 195 to about 205 μm, or about 104 μm, about 108 μm, about 112 μm, about 116 μm, about 120 μm, about 124 μm, about 128 μm, about 132 μm, about 136 μm, about 140 μm, about 144 μm, about 148 μm, about 152 μm, about 156 μm, about 160 μm, about 164 μm, about 168 μm, about 172 μm, about 176 μm, about 180 μm, about 184 μm, about 188 μm, about 192 μm, about 196 μm, about 200 μm, about 204 μm, about 208 μm, about 212 μm, about 216 μm, about 220 μm, about 224 μm, about 228 μm, about 232 μm, about 236 μm, about 240 μm, about 244 μm, about 248 μm, about 252 μm, about 256 μm, about 260 μm, about 264 μm, about 268 μm, about 272 μm, about 276 μm, about 280 μm, about 284 μm, about 288 μm, about 292 μm, about 296 μm, about 300 μm. In some embodiments, the coarse grade marble in the form of irregular-shaped particles has a D₁₀ particle size of about 208 μm.

In some embodiments, the coarse grade marble in the form of irregular-shaped particles has a D₅₀ particle size of about 350 to about 750 μm, such as about 310 to about 740 μm, about 320 to about 730 μm, about 330 to about 720 μm, about 340 to about 710 μm, about 350 to about 700 μm, about 360 to about 690 μm, about 370 to about 680 μm, about 380 to about 670 μm, about 390 to about 660 μm, about 400 to about 650 μm, about 410 to about 640 μm, about 420 to about 630 μm, about 430 to about 620 μm, about 440 to about 610 μm, about 450 to about 600 μm, about 460 to about 590 μm, about 470 to about 580 μm, about 480 to about 570 μm, about 490 to about 560 μm, about 500 to about 550 μm, about 510 to about 540 μm, about 520 to about 530 μm, or about 358 μm, about 368 μm, about 378 μm, about 388 μm, about 398 μm, about 408 μm, about 418 μm, about 428 μm, about 438 μm, about 448 μm, about 458 μm, about 468 μm, about 478 μm, about 488 μm, about 498 μm, about 508 μm, about 518 μm, about 528 μm, about 538 μm, about 548 μm, about 558 μm, about 568 μm, about 578 μm, about 588 μm, about 598 μm, about 608 μm, about 618 μm, about 628 μm, about 638 μm, about 648 μm, about 658 μm, about 668 μm, about 678 μm, about 688 μm, about 698 μm, about 708 μm, about 718 μm, about 728 μm, about 738 μm, about 748 μm. In some embodiments, the coarse grade marble in the form of irregular-shaped particles has a D₅₀ particle size of about 568 μm.

In some embodiments, the coarse grade marble in the form of irregular-shaped particles has a D₉₀ particle size of about 600 to about 1100 μm, such as about 620 to about 1080 μm, about 640 to about 1060 μm, about 660 to about 1040 μm, about 680 to about 1020 μm, about 700 to about 1000 μm, about 720 to about 980 μm, about 740 to about 960 μm, about 760 to about 940 μm, about 780 to about 920 μm, about 800 to about 900 μm, about 820 to about 880 μm, about 840 to about 860 μm, or about 606 μm, about 626 μm, about 646 μm, about 666 μm, about 686 μm, about 706 μm, about 726 μm, about 746 μm, about 766 μm, about 786 μm, about 806 μm, about 826 μm, about 846 μm, about 866 μm, about 886 μm, about 906 μm, about 926 μm, about 946 μm, about 966 μm, about 986 μm, about 1006 μm, about 1026 μm, about 1046 μm, about 1066 μm, or about 1086 μm. In some embodiments, the coarse grade marble in the form of irregular-shaped particles has a D₉₀ particle size of about 886 μm.

In some embodiments, the fine grade marble includes about 87.1 to about 91.1 wt. % of dolomite (CaMg(CO₃)₂), such as about 87.5 to about 90.7 wt. %, about 87.9 to about 90.3 wt. %, about 88.3 to about 89.9 wt. %, about 88.7 to about 89.5 wt. %, or about 87.1 wt. %, about 87.3 wt. %, about 87.5 wt. %, about 87.7 wt. %, about 87.9 wt. %, about 88.1 wt. %, about 88.3 wt. %, about 88.5 wt. %, about 88.7 wt. %, about 88.9 wt. %, about 89.1 wt. %, about 89.3 wt. %, about 89.5 wt. %, about 89.7 wt. %, about 89.9 wt. %, about 90.1 wt. %, about 90.3 wt. %, about 90.5 wt. %, about 90.7 wt. %, about 90.9 wt. %, about 91.1 wt. % of dolomite. In some embodiments, the fine grade marble includes about 8.9 to about 12.9 wt. % of calcite (CaCO₃), such as about 9.1 to about 12.3 wt. %, about 9.3 to about 12.1 wt. %, about 9.5 to about 11.9 wt. %, about 9.7 to about 11.7 wt. %, about 9.9 to about 11.5 wt. %, about 10.1 to about 11.3 wt. %, about 10.3 to about 11.1 wt. %, about 10.5 to about 10.9 wt. %, or about 8.9 wt. %, about 9.05 wt. %, about 9.2 wt. %, about 9.35 wt. %, about 9.5 wt. %, about 9.65 wt. %, about 9.8 wt. %, about 9.95 wt. %, about 10.1 wt. %, about 10.25 wt. %, about 10.4 wt. %, about 10.55 wt. %, about 10.7 wt. %, about 10.85 wt. %, about 11.0 wt. %, about 11.15 wt. %, about 11.3 wt. %, about 11.45 wt. %, about 11.6 wt. %, about 11.75 wt. %, about 11.9 wt. %, about 12.05 wt. %, about 12.2 wt. %, about 12.35 wt. %, about 12.5 wt. %, about 12.65 wt. %, about 12.8 wt. %, or about 12.9 wt. % of calcite. In some embodiments, fine grade marble includes about 89.1 wt. % of dolomite and about 10.9 wt. % of calcite, each wt. % based on a total weight of the fine grade marble.

In some embodiments, the medium grade marble includes about 91.7 to about 95.7 wt. % of dolomite, such as about 92.0 to about 95.2 wt. %, about 92.3 to about 94.9 wt. %, about 92.6 to about 94.6 wt. %, about 92.9 to about 94.3 wt. %, about 93.2 to about 94.0 wt. %, about 93.5 to about 93.7 wt. %, or about 92.0 wt. %, about 92.4 wt. %, about 92.8 wt. %, about 93.2 wt. %, about 93.6 wt. %, about 94.0 wt. %, about 94.4 wt. %, about 94.8 wt. %, about 95.2 wt. %, or about 95.6 wt. % of dolomite. In some embodiments, the medium grade marble includes about 4.3 to about 8.3 wt. % of calcite, such as about 4.5 to about 8.1 wt. %, about 4.7 to about 7.9 wt. %, about 4.9 to about 7.7 wt. %, about 5.1 to about 7.5 wt. %, about 5.3 to about 7.3 wt. %, about 5.5 to about 7.1 wt. %, about 5.7 to about 6.9 wt. %, about 5.9 to about 6.7 wt. %, about 6.1 to about 6.5 wt. %, or about 4.6 wt. %, about 4.9 wt. %, about 5.2 wt. %, about 5.5 wt. %, about 5.8 wt. %, about 6.1 wt. %, about 6.4 wt. %, about 6.7 wt. %, about 7.0 wt. %, about 7.3 wt. %, about 7.6 wt. %, about 7.9 wt. %, about 8.2 wt. %, or about 8.3 wt. %. In some embodiments, the medium grade marble includes about 93.7 wt. % of dolomite and about 6.3 wt. % of calcite, each wt. % based on a total weight of the medium grade marble.

In some embodiments, the coarse grade marble includes about 84 to about 88 wt. % of dolomite, such as about 84.3 to about 87.7 wt. %, about 84.6 to about 87.4 wt. %, about 84.9 to about 87.1 wt. %, about 85.2 to about 86.8 wt. %, about 85.5 to about 86.5 wt. %, about 85.8 to about 86.2 wt. %, or about 84.2 wt. %, about 84.4 wt. %, about 84.6 wt. %, about 84.8 wt. %, about 85.0 wt. %, about 85.2 wt. %, about 85.4 wt. %, about 85.6 wt. %, about 85.8 wt. %, about 86.0 wt. %, about 86.2 wt. %, about 86.4 wt. %, about 86.6 wt. %, about 86.8 wt. %, about 87.0 wt. %, about 87.2 wt. %, about 87.4 wt. %, about 87.6 wt. %, about 87.8 wt. %, or about 88.0 wt. % of dolomite. In some embodiments, the coarse grade marble includes about 12 to about 16 wt. % of calcite, such as about 12.3 to about 15.7 wt. %, about 12.6 to about 15.4 wt. %, about 12.9 to about 15.1 wt. %, about 13.2 to about 14.8 wt. %, about 13.5 to about 14.5 wt. %, about 13.8 to about 14.2 wt. %, or about 12.2 wt. %, about 12.4 wt. %, about 12.6 wt. %, about 12.8 wt. %, about 13.0 wt. %, about 13.2 wt. %, about 13.4 wt. %, about 13.6 wt. %, about 13.8 wt. %, about 14.0 wt. %, about 14.2 wt. %, about 14.4 wt. %, about 14.6 wt. %, about 14.8 wt. %, about 15.0 wt. %, about 15.2 wt. %, about 15.4 wt. %, about 15.6 wt. %, about 15.8 wt. %, about 16.0 wt. % of calcite. In some embodiments, the coarse grade marble includes about 86.0 wt. % of dolomite and about 14.0 wt. % of calcite, each wt. % based on a total weight of the coarse grade marble.

In some embodiments, the fine grade marble has a surface area of about 600 to about 1000 square meters per kilogram (m²/kg), such as about 620 to about 980 m²/kg, about 640 to about 960 m²/kg, about 660 to about 940 m²/kg, about 680 to about 920 m²/kg, about 700 to about 900 m²/kg, about 720 to about 880 m²/kg, about 740 to about 860 m²/kg, about 760 to about 840 m²/kg, about 780 to about 820 m²/kg, or about 800 to about 800 m²/kg. In some embodiments, the fine grade marble has a surface area of about 810.4 m²/kg.

In some embodiments, the medium grade marble has a surface area of about 100 to about 400 m²/kg, such as about 120 to about 380 m²/kg, about 140 to about 360 m²/kg, about 160 to about 340 m²/kg, about 180 to about 320 m²/kg, about 200 to about 300 m²/kg, about 220 to about 280 m²/kg, about 240 to about 260 m²/kg, or about 250 m²/kg. In some embodiments, the medium grade marble has a surface area of about 230.9 m²/kg.

In some embodiments, the coarse grade marble has a surface area of about 30 to about 100 m²/kg, such as about 35 to about 95 m²/kg, about 40 to about 90 m²/kg, about 45 to about 85 m²/kg, about 50 to about 80 m²/kg, about 55 to about 75 m²/kg, about 60 to about 70 m²/kg, or about 65 m²/kg. In some embodiments, the coarse grade marble has a surface area of about 56.87 m²/kg.

In some embodiments, the specific gravity (SG) of fine grade marble is about 2.8 to about 3.0, such as about 2.82 to about 2.98, about 2.84 to about 2.96, about 2.86 to about 2.94, about 2.88 to about 2.92, or about 2.90. In some embodiments, the SG of fine grade marble is about 2.89.

In some embodiments, the SG of medium grade marble is about 2.8 to about 3.0, such as about 2.82 to about 2.98, about 2.84 to about 2.96, about 2.86 to about 2.94, about 2.88 to about 2.92, or about 2.90. In some embodiments, the SG of medium grade marble is about 2.89.

In some embodiments, the SG of coarse grade marble is about 2.8 to about 3.0, such as about 2.82 to about 2.98, about 2.84 to about 2.96, about 2.86 to about 2.94, about 2.88 to about 2.92, or about 2.90. In some embodiments, the SG of coarse grade marble is about 2.89.

In some embodiments, the cement sack composition includes an API Class A Portland cement and about 1 to about 20% coarse grade marble by weight substitution of the API Class A Portland cement in the cement sack composition, such as about 2 to about 18%, about 3 to about 16%, about 4 to about 14%, about 5 to about 12%, about 6 to about 10%, about 8 to about 10%, or about 1%, about 3%, about 5%, about 7%, about 9%, about 11%, about 13%, about 15%, about 17%, or about 19% coarse grade marble by weight substitution of the API Class A Portland cement in the cement sack composition.

In some embodiments, the cement sack composition includes an API Class A ordinary (O) Portland cement and about 1 to about 20% coarse grade marble by weight substitution of the API Class A ordinary Portland cement in the cement sack composition, such as about 2 to about 18%, about 3 to about 16%, about 4 to about 14%, about 5 to about 12%, about 6 to about 10%, about 8 to about 10%, or about 1%, about 3%, about 5%, about 7%, about 9%, about 11%, about 13%, about 15%, about 17%, or about 19% coarse grade marble by weight substitution of the API Class A ordinary Portland cement in the cement sack composition. In some embodiments, the cement sack composition includes an API Class A ordinary Portland cement and about 1% coarse grade marble by weight substitution of the API Class A ordinary Portland cement in the cement sack composition. In some embodiments, the cement sack composition includes an API Class A ordinary Portland cement and about 5% coarse grade marble by weight substitution of the API Class A ordinary Portland cement in the cement sack composition. In some embodiments, the cement sack composition includes an API Class A ordinary Portland cement and about 9% coarse grade marble by weight substitution of the API Class A ordinary Portland cement in the cement sack composition. In some embodiments, the cement sack composition includes an API Class A ordinary Portland cement and about 13% coarse grade marble by weight substitution of the API Class A ordinary Portland cement in the cement sack composition. In some embodiments, the cement sack composition includes an API Class A ordinary Portland cement and about 17% coarse grade marble by weight substitution of the API Class A ordinary Portland cement in the cement sack composition.

In some embodiments, the cement sack composition includes an API Class A Portland cement and about 0.01 to about 5% medium grade marble by weight substitution of the API Class A Portland cement in the cement sack composition, such as about 0.05 to about 4.5%, about 0.1 to about 4%, about 0.5 to about 3.5%, about 1 to about 3%, about 1.5 to about 2.5%, about 2 to about 2.5%, or about 0.01%, about 0.05%, about 0.5%, about 1%, about 1.25%, about 1.5%, about 1.75%, about 2%, about 2.25%, about 2.5%, about 2.75%, about 3%, about 3.25%, about 3.5%, about 3.75%, about 4%, about 4.25%, about 4.5%, about 4.75%, or about 5% medium grade marble by weight substitution of the API Class A Portland cement in the cement sack composition.

In some embodiments, the cement sack composition includes an API Class A ordinary Portland cement and about 0.01 to about 5% medium grade marble by weight substitution of the API Class A ordinary Portland cement in the cement sack composition, such as about 0.05 to about 4.5%, about 0.1 to about 4%, about 0.5 to about 3.5%, about 1 to about 3%, about 1.5 to about 2.5%, about 2 to about 2.5%, or about 0.01%, about 0.05%, about 0.5%, about 1%, about 1.25%, about 1.5%, about 1.75%, about 2%, about 2.25%, about 2.5%, about 2.75%, about 3%, about 3.25%, about 3.5%, about 3.75%, about 4%, about 4.25%, about 4.5%, about 4.75%, or about 5% medium grade marble by weight substitution of the API Class A ordinary Portland cement in the cement sack composition. In some embodiments, the cement sack composition includes an API Class A ordinary Portland cement and about 0.01% medium grade marble by weight substitution of the API Class A ordinary Portland cement in the cement sack composition. In some embodiments, the cement sack composition includes an API Class A ordinary Portland cement and about 0.5% medium grade marble by weight substitution of the API Class A ordinary Portland cement in the cement sack composition. In some embodiments, the cement sack composition includes an API Class A ordinary Portland cement and about 1% medium grade marble by weight substitution of the API Class A ordinary Portland cement in the cement sack composition. In some embodiments, the cement sack composition includes an API Class A ordinary Portland cement and about 1.5% medium grade marble by weight substitution of the API Class A ordinary Portland cement in the cement sack composition. In some embodiments, the cement sack composition includes an API Class A ordinary Portland cement and about 2% medium grade marble by weight substitution of the API Class A ordinary Portland cement in the cement sack composition. In some embodiments, the cement sack composition includes an API Class A ordinary Portland cement and about 2.5% medium grade marble by weight substitution of the API Class A ordinary Portland cement in the cement sack composition. In some embodiments, the cement sack composition includes an API Class A ordinary Portland cement and about 3% medium grade marble by weight substitution of the API Class A ordinary Portland cement in the cement sack composition. In some embodiments, the cement sack composition includes an API Class A ordinary Portland cement and about 3.5% medium grade marble by weight substitution of the API Class A ordinary Portland cement in the cement sack composition. In some embodiments, the cement sack composition includes an API Class A ordinary Portland cement and about 4% medium grade marble by weight substitution of the API Class A ordinary Portland cement in the cement sack composition. In some embodiments, the cement sack composition includes an API Class A ordinary Portland cement and about 4.5% medium grade marble by weight substitution of the API Class A ordinary Portland cement in the cement sack composition. In some embodiments, the cement sack composition includes an API Class A ordinary Portland cement and about 5% medium grade marble by weight substitution of the API Class A ordinary Portland cement in the cement sack composition.

In some embodiments, the cement sack composition includes an API Class C Portland cement and about 0.1 to about 15% coarse grade marble by weight substitution of the API Class C Portland cement in the cement sack composition, such as about 0.5 to about 14%, about 1 to about 13%, about 2 to about 12%, about 3 to about 11%, about 4 to about 10%, about 5 to about 9%, about 6 to about 8%, or about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, or about 14.5% coarse grade marble by weight substitution of the API Class C Portland cement in the cement sack composition.

In some embodiments, the cement sack composition includes an API Class C ordinary (O) Portland cement and about 0.1 to about 15% coarse grade marble by weight substitution of the API Class C ordinary Portland cement in the cement sack composition, such as about 0.5 to about 14%, about 1 to about 13%, about 2 to about 12%, about 3 to about 11%, about 4 to about 10%, about 5 to about 9%, about 6 to about 8%, or about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, or about 14.5% coarse grade marble by weight substitution of the API Class C ordinary Portland cement in the cement sack composition. In some embodiments, the cement sack composition includes an API Class C ordinary Portland cement and about 0.1% coarse grade marble by weight substitution of the API Class C ordinary Portland cement in the cement sack composition. In some embodiments, the cement sack composition includes an API Class C ordinary Portland cement and about 3% coarse grade marble by weight substitution of the API Class C ordinary Portland cement in the cement sack composition. In some embodiments, the cement sack composition includes an API Class C ordinary Portland cement and about 5% coarse grade marble by weight substitution of the API Class C ordinary Portland cement in the cement sack composition. In some embodiments, the cement sack composition includes an API Class C ordinary Portland cement and about 7% coarse grade marble by weight substitution of the API Class C ordinary Portland cement in the cement sack composition. In some embodiments, the cement sack composition includes an API Class C ordinary Portland cement and about 9% coarse grade marble by weight substitution of the API Class C ordinary Portland cement in the cement sack composition.

In some embodiments, the cement sack composition includes an API Class C medium sulfate-resistant (MSR) grade Portland cement and about 1 to about 15% coarse grade marble by weight substitution of the API Class C MSR grade Portland cement in the cement sack composition, such as about 2 to about 14%, about 3 to about 13%, about 4 to about 12%, about 5 to about 11%, about 6 to about 10%, about 7 to about 9%, or about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, or about 14.5% coarse grade marble by weight substitution of the API Class C MSR grade Portland cement in the cement sack composition. In some embodiments, the cement sack composition includes an API Class C MSR grade Portland cement and about 1% coarse grade marble by weight substitution of the API Class C MSR grade Portland cement in the cement sack composition. In some embodiments, the cement sack composition includes an API Class C MSR grade Portland cement and about 4% coarse grade marble by weight substitution of the API Class C MSR grade Portland cement in the cement sack composition. In some embodiments, the cement sack composition includes an API Class C MSR grade Portland cement and about 7% coarse grade marble by weight substitution of the API Class C MSR grade Portland cement in the cement sack composition. In some embodiments, the cement sack composition includes an API Class C MSR grade Portland cement and about 10% coarse grade marble by weight substitution of the API Class C MSR grade Portland cement in the cement sack composition. In some embodiments, the cement sack composition includes an API Class C MSR grade Portland cement and about 13% coarse grade marble by weight substitution of the API Class C MSR grade Portland cement in the cement sack composition.

In some embodiments, the cement sack composition includes an API Class C high sulfate-resistant (HSR) grade Portland cement and about 1 to about 15% coarse grade marble by weight substitution of the API Class C HRS grade Portland cement in the cement sack composition, such as about 2 to about 14%, about 3 to about 13%, about 4 to about 12%, about 5 to about 11%, about 6 to about 10%, about 7 to about 9%, or about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, or about 14.5% coarse grade marble by weight substitution of the API Class C HRS grade Portland cement in the cement sack composition. In some embodiments, the cement sack composition includes an API Class C HSR grade Portland cement and about 1% coarse grade marble by weight substitution of the API Class C HRS grade Portland cement in the cement sack composition. In some embodiments, the cement sack composition includes an API Class C HSR grade Portland cement and about 4% coarse grade marble by weight substitution of the API Class C HRS grade Portland cement in the cement sack composition. In some embodiments, the cement sack composition includes an API Class C HSR grade Portland cement and about 7% coarse grade marble by weight substitution of the API Class C HRS grade Portland cement in the cement sack composition. In some embodiments, the cement sack composition includes an API Class C HSR grade Portland cement and about 10% coarse grade marble by weight substitution of the API Class C HRS grade Portland cement in the cement sack composition. In some embodiments, the cement sack composition includes an API Class C HSR grade Portland cement and about 13% coarse grade marble by weight substitution of the API Class C HRS grade Portland cement in the cement sack composition.

In some embodiments, the cement sack composition includes an API Class C Portland cement and about 0.01 to about 5% medium grade marble by weight substitution of the API Class C Portland cement in the cement sack composition, such as about 0.05 to about 4.5%, about 0.1 to about 4%, about 0.5 to about 3.5%, about 1 to about 3%, about 1.5 to about 2.5%, about 2 to about 2.5%, or about 0.01%, about 0.05%, about 0.5%, about 1%, about 1.25%, about 1.5%, about 1.75%, about 2%, about 2.25%, about 2.5%, about 2.75%, about 3%, about 3.25%, about 3.5%, about 3.75%, about 4%, about 4.25%, about 4.5%, about 4.75%, or about 5% medium grade marble by weight substitution of the API Class C Portland cement in the cement sack composition.

In some embodiments, the cement sack composition includes an API Class C ordinary Portland cement and about 0.01 to about 3% medium grade marble by weight substitution of the API Class C ordinary Portland cement in the cement sack composition, such as about 0.05 to about 2.5%, about 0.1 to about 2.5%, about 0.5 to about 2.5%, about 1 to about 2%, about 1.5 to about 2%, or about 0.01%, about 0.05%, about 0.5%, about 1%, about 1.25%, about 1.5%, about 1.75%, about 2%, about 2.25%, about 2.5%, about 2.75%, or about 3% medium grade marble by weight substitution of the API Class C ordinary Portland cement in the cement sack composition. In some embodiments, the cement sack composition includes an API Class C ordinary Portland cement and about 0.01% medium grade marble by weight substitution of the API Class C ordinary Portland cement in the cement sack composition. In some embodiments, the cement sack composition includes an API Class C ordinary Portland cement and about 0.1% medium grade marble by weight substitution of the API Class C ordinary Portland cement in the cement sack composition. In some embodiments, the cement sack composition includes an API Class C ordinary Portland cement and about 1% medium grade marble by weight substitution of the API Class C ordinary Portland cement in the cement sack composition. In some embodiments, the cement sack composition includes an API Class C ordinary Portland cement and about 2% medium grade marble by weight substitution of the API Class C ordinary Portland cement in the cement sack composition. In some embodiments, the cement sack composition includes an API Class C ordinary Portland cement and about 3% medium grade marble by weight substitution of the API Class C ordinary Portland cement in the cement sack composition.

In some embodiments, the cement sack composition includes an API Class C MSR grade Portland cement and about 0.01 to about 4% medium grade marble by weight substitution of the API Class C MSR grade Portland cement in the cement sack composition, such as about 0.05 to about 3.5%, about 0.1 to about 3%, about 0.5 to about 2.5%, about 1 to about 2.5%, about 1.5 to about 2%, about or about 0.01%, about 0.05%, about 0.5%, about 1%, about 1.25%, about 1.5%, about 1.75%, about 2%, about 2.25%, about 2.5%, about 2.75%, about 3%, about 3.25%, about 3.5%, about 3.75%, or about 4% medium grade marble by weight substitution of the API Class C MSR grade Portland cement in the cement sack composition. In some embodiments, the cement sack composition includes an API Class C MSR grade Portland cement and about 0.01% medium grade marble by weight substitution of the API Class C MSR grade Portland cement in the cement sack composition. In some embodiments, the cement sack composition includes an API Class C MSR grade Portland cement and about 0.1% medium grade marble by weight substitution of the API Class C MSR grade Portland cement in the cement sack composition. In some embodiments, the cement sack composition includes an API Class C MSR grade Portland cement and about 1% medium grade marble by weight substitution of the API Class C MSR grade Portland cement in the cement sack composition. In some embodiments, the cement sack composition includes an API Class C MSR grade Portland cement and about 2% medium grade marble by weight substitution of the API Class C MSR grade Portland cement in the cement sack composition. In some embodiments, the cement sack composition includes an API Class C MSR grade Portland cement and about 3% medium grade marble by weight substitution of the API Class C MSR grade Portland cement in the cement sack composition. In some embodiments, the cement sack composition includes an API Class C MSR grade Portland cement and about 4% medium grade marble by weight substitution of the API Class C MSR grade Portland cement in the cement sack composition.

In some embodiments, the cement sack composition includes an API Class C HSR grade Portland cement and about 0.01 to about 5% medium grade marble by weight substitution of the API Class C HSR grade Portland cement in the cement sack composition, such as about 0.05 to about 4.5%, about 0.1 to about 4%, about 0.5 to about 3.5%, about 1 to about 3%, about 1.5 to about 2.5%, about 2 to about 2.5%, or about 0.01%, about 0.05%, about 0.5%, about 1%, about 1.25%, about 1.5%, about 1.75%, about 2%, about 2.25%, about 2.5%, about 2.75%, about 3%, about 3.25%, about 3.5%, about 3.75%, about 4%, about 4.25%, about 4.5%, about 4.75%, or about 5% medium grade marble by weight substitution of the API Class C HSR grade Portland cement in the cement sack composition. In some embodiments, the cement sack composition includes an API Class C HSR grade Portland cement and about 0.01% medium grade marble by weight substitution of the API Class C HSR grade Portland cement in the cement sack composition. In some embodiments, the cement sack composition includes an API Class C HSR grade Portland cement and about 0.1% medium grade marble by weight substitution of the API Class C HSR grade Portland cement in the cement sack composition. In some embodiments, the cement sack composition includes an API Class C HSR grade Portland cement and about 1% medium grade marble by weight substitution of the API Class C HSR grade Portland cement in the cement sack composition. In some embodiments, the cement sack composition includes an API Class C HSR grade Portland cement and about 2% medium grade marble by weight substitution of the API Class C HSR grade Portland cement in the cement sack composition. In some embodiments, the cement sack composition includes an API Class C HSR grade Portland cement and about 3% medium grade marble by weight substitution of the API Class C HSR grade Portland cement in the cement sack composition. In some embodiments, the cement sack composition includes an API Class C HSR grade Portland cement and about 4% medium grade marble by weight substitution of the API Class C HSR grade Portland cement in the cement sack composition. In some embodiments, the cement sack composition includes an API Class C HSR grade Portland cement and about 5% medium grade marble by weight substitution of the API Class C HSR grade Portland cement in the cement sack composition.

In some embodiments, the cement sack composition includes an API Class G Portland cement and about 0.01 to about 15% coarse grade marble by weight substitution in the cement sack composition, such as about 0.5 to about 14%, about 1 to about 13%, about 2 to about 12%, about 3 to about 11%, about 4 to about 10%, about 5 to about 9%, about 6 to about 8%, or about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, or about 14.5% coarse grade marble by weight substitution of the API Class G Portland cement in the cement sack composition. In some embodiments, the cement sack composition includes an API Class G Portland cement and about 0.1% coarse grade marble by weight substitution of the API Class G Portland cement in the cement sack composition. In some embodiments, the cement sack composition includes an API Class G Portland cement and about 3% coarse grade marble by weight substitution of the API Class G Portland cement in the cement sack composition. In some embodiments, the cement sack composition includes an API Class G Portland cement and about 5% coarse grade marble by weight substitution of the API Class G Portland cement in the cement sack composition. In some embodiments, the cement sack composition includes an API Class G Portland cement and about 7% coarse grade marble by weight substitution of the API Class G Portland cement in the cement sack composition. In some embodiments, the cement sack composition includes an API Class G Portland cement and about 9% coarse grade marble by weight substitution of the API Class G Portland cement in the cement sack composition. In some embodiments, the cement sack composition includes an API Class G Portland cement and about 11% coarse grade marble by weight substitution of the API Class G Portland cement in the cement sack composition. In some embodiments, the cement sack composition includes an API Class G Portland cement and about 13% coarse grade marble by weight substitution of the API Class G Portland cement in the cement sack composition. In some embodiments, the cement sack composition includes an API Class G Portland cement and about 15% coarse grade marble by weight substitution of the API Class G Portland cement in the cement sack composition.

In some embodiments, the cement sack composition includes an API Class G MSR grade Portland cement and about 0.01 to about 10% coarse grade marble by weight substitution of the API Class G MSR grade Portland cement in the cement sack composition, such as about 0.5 to about 9%, about 1 to about 8%, about 2 to about 7%, about 3 to about 6%, about 4 to about 5%, or about 0.1%, about 0.5%, about 1.5%, about 2.5%, about 3.5%, about 4.5%, about 5.5%, about 6.5%, about 7.5%, about 8.5%, about or 9.5% coarse grade marble by weight substitution of the API Class G MSR grade Portland cement in the cement sack composition. In some embodiments, the cement sack composition includes an API Class G MSR grade Portland cement and about 0.1% coarse grade marble by weight substitution of the API Class G MSR grade Portland cement in the cement sack composition. In some embodiments, the cement sack composition includes an API Class G MSR grade Portland cement and about 3% coarse grade marble by weight substitution of the API Class G MSR grade Portland cement in the cement sack composition. In some embodiments, the cement sack composition includes an API Class G MSR grade Portland cement and about 5% coarse grade marble by weight substitution of the API Class G MSR grade Portland cement in the cement sack composition. In some embodiments, the cement sack composition includes an API Class G MSR grade Portland cement and about 7% coarse grade marble by weight substitution of the API Class G MSR grade Portland cement in the cement sack composition. In some embodiments, the cement sack composition includes an API Class G MSR grade Portland cement and about 9% coarse grade marble by weight substitution of the API Class G MSR grade Portland cement in the cement sack composition.

In some embodiments, the cement sack composition includes an API Class G HSR grade Portland cement and about 0.01 to about 15% coarse grade marble by weight substitution of the API Class G HSR grade Portland cement in the cement sack composition, such as about 0.5 to about 14%, about 1 to about 13%, about 2 to about 12%, about 3 to about 11%, about 4 to about 10%, about 5 to about 9%, about 6 to about 8%, or about 0.1%, about 0.5%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, or about 14.5% coarse grade marble by weight substitution of the API Class G HSR grade Portland cement in the cement sack composition. In some embodiments, the cement sack composition includes an API Class G HSR grade Portland cement and about 0.1% coarse grade marble by weight substitution of the API Class G HSR grade Portland cement in the cement sack composition. In some embodiments, the cement sack composition includes an API Class G HSR grade Portland cement and about 3% coarse grade marble by weight substitution of the API Class G HSR grade Portland cement in the cement sack composition. In some embodiments, the cement sack composition includes an API Class G HSR grade Portland cement and about 5% coarse grade marble by weight substitution of the API Class G HSR grade Portland cement in the cement sack composition. In some embodiments, the cement sack composition includes an API Class G HSR grade Portland cement and about 7% coarse grade marble by weight substitution of the API Class G HSR grade Portland cement in the cement sack composition. In some embodiments, the cement sack composition includes an API Class G HSR grade Portland cement and about 9% coarse grade marble by weight substitution of the API Class G HSR grade Portland cement in the cement sack composition. In some embodiments, the cement sack composition includes an API Class G HSR grade Portland cement and about 11% coarse grade marble by weight substitution of the API Class G HSR grade Portland cement in the cement sack composition. In some embodiments, the cement sack composition includes an API Class G HSR grade Portland cement and about 13% coarse grade marble by weight substitution of the API Class G HSR grade Portland cement in the cement sack composition. In some embodiments, the cement sack composition includes an API Class G HSR grade Portland cement and about 15% coarse grade marble by weight substitution of the API Class G HSR grade Portland cement in the cement sack composition.

In some embodiments, the cement sack composition includes an API Class G Portland cement and about 0.01 to about 30% medium grade marble by weight substitution of the API Class G Portland cement in the cement sack composition, such as about 0.5 to about 27%, about 1 to about 24%, about 4 to about 21%, about 7 to about 18%, about 10 to about 15%, about 12 to about 14%, or about 0.05%, about 0.5%, about 1%, about 5%, about 9%, about 13%, about 17%, about 21%, or about 25% medium grade marble by weight substitution of the API Class G Portland cement in the cement sack composition. In some embodiments, the cement sack composition includes an API Class G Portland cement and about 0.01% medium grade marble by weight substitution of the API Class G Portland cement in the cement sack composition. In some embodiments, the cement sack composition includes an API Class G Portland cement and about 1% medium grade marble by weight substitution of the API Class G Portland cement in the cement sack composition. In some embodiments, the cement sack composition includes an API Class G Portland cement and about 5% medium grade marble by weight substitution of the API Class G Portland cement in the cement sack composition. In some embodiments, the cement sack composition includes an API Class G Portland cement and about 10% medium grade marble by weight substitution of the API Class G Portland cement in the cement sack composition. In some embodiments, the cement sack composition includes an API Class G Portland cement and about 15% medium grade marble by weight substitution of the API Class G Portland cement in the cement sack composition. In some embodiments, the cement sack composition includes an API Class G Portland cement and about 20% medium grade marble by weight substitution of the API Class G Portland cement in the cement sack composition. In some embodiments, the cement sack composition includes an API Class G Portland cement and about 25% medium grade marble by weight substitution of the API Class G Portland cement in the cement sack composition. In some embodiments, the cement sack composition includes an API Class G Portland cement and about 30% medium grade marble by weight substitution of the API Class G Portland cement in the cement sack composition.

In some embodiments, the cement sack composition includes an API Class G MSR grade Portland cement and about 0.01 to about 20% medium grade marble by weight substitution of the API Class G MSR grade Portland cement in the cement sack composition, such as about 0.5 to about 18%, about 1 to about 16%, about 3 to about 14%, about 5 to about 12%, about 7 to about 10%, about 8 to about 9%, or about 0.05%, about 0.5%, about 1%, about 5%, about 9%, about 13%, about 17%, or about 19% medium grade marble by weight substitution of the API Class G MSR grade Portland cement in the cement sack composition. In some embodiments, the cement sack composition includes an API Class G MSR grade Portland cement and about 0.01% medium grade marble by weight substitution of the API Class G MSR grade Portland cement in the cement sack composition. In some embodiments, the cement sack composition includes an API Class G MSR grade Portland cement and about 1% medium grade marble by weight substitution of the API Class G MSR grade Portland cement in the cement sack composition. In some embodiments, the cement sack composition includes an API Class G MSR grade Portland cement and about 5% medium grade marble by weight substitution of the API Class G MSR grade Portland cement in the cement sack composition. In some embodiments, the cement sack composition includes an API Class G MSR grade Portland cement and about 10% medium grade marble by weight substitution of the API Class G MSR grade Portland cement in the cement sack composition. In some embodiments, the cement sack composition includes an API Class G MSR grade Portland cement and about 15% medium grade marble by weight substitution of the API Class G MSR grade Portland cement in the cement sack composition. In some embodiments, the cement sack composition includes an API Class G MSR grade Portland cement and about 20% medium grade marble by weight substitution of the API Class G MSR grade Portland cement in the cement sack composition.

In some embodiments, the cement sack composition includes an API Class G HSR grade Portland cement and about 0.01 to about 30% medium grade marble by weight substitution of the API Class G HSR grade Portland cement in the cement sack composition, such as about 0.5 to about 27%, about 1 to about 24%, about 4 to about 21%, about 7 to about 18%, about 10 to about 15%, about 12 to about 14%, or about 0.05%, about 0.5%, about 1%, about 5%, about 9%, about 13%, about 17%, about 21%, or about 25% medium grade marble by weight substitution of the API Class G HSR grade Portland cement in the cement sack composition. In some embodiments, the cement sack composition includes an API Class G HSR grade Portland cement and about 0.01% medium grade marble by weight substitution of the API Class G HSR grade Portland cement in the cement sack composition. In some embodiments, the cement sack composition includes an API Class G HSR grade Portland cement and about 1% medium grade marble by weight substitution of the API Class G HSR grade Portland cement in the cement sack composition. In some embodiments, the cement sack composition includes an API Class G HSR grade Portland cement and about 5% medium grade marble by weight substitution of the API Class G HSR grade Portland cement in the cement sack composition. In some embodiments, the cement sack composition includes an API Class G HSR grade Portland cement and about 10% medium grade marble by weight substitution of the API Class G HSR grade Portland cement in the cement sack composition. In some embodiments, the cement sack composition includes an API Class G HSR grade Portland cement and about 15% medium grade marble by weight substitution of the API Class G HSR grade Portland cement in the cement sack composition. In some embodiments, the cement sack composition includes an API Class G HSR grade Portland cement and about 20% medium grade marble by weight substitution of the API Class G HSR grade Portland cement in the cement sack composition. In some embodiments, the cement sack composition includes an API Class G HSR grade Portland cement and about 25% medium grade marble by weight substitution of the API Class G HSR grade Portland cement in the cement sack composition. In some embodiments, the cement sack composition includes an API Class G HSR grade Portland cement and about 30% medium grade marble by weight substitution of the API Class G HSR grade Portland cement in the cement sack composition.

In some embodiments, the cement sack composition includes an API Class G Portland cement and about 1 to about 40% fine grade marble by weight substitution of the API Class G Portland cement in the cement sack composition, such as about 4 to about 37%, about 7 to about 34%, about 10 to about 31%, about 13 to about 28%, about 16 to about 25%, about 19 to about 22%, or about 1%, about 5%, about 10%, about 15%, about 20%, about 25%, about 30%, about 35%, or about 40% fine grade marble by weight substitution of the API Class G Portland cement in the cement sack composition. In some embodiments, the cement sack composition includes an API Class G Portland cement and about 5% fine grade marble by weight substitution of the API Class G Portland cement in the cement sack composition. In some embodiments, the cement sack composition includes an API Class G Portland cement and about 10% fine grade marble by weight substitution of the API Class G Portland cement in the cement sack composition. In some embodiments, the cement sack composition includes an API Class G Portland cement and about 15% fine grade marble by weight substitution of the API Class G Portland cement in the cement sack composition. In some embodiments, the cement sack composition includes an API Class G Portland cement and about 20% fine grade marble by weight substitution of the API Class G Portland cement in the cement sack composition. In some embodiments, the cement sack composition includes an API Class G Portland cement and about 25% fine grade marble by weight substitution of the API Class G Portland cement in the cement sack composition. In some embodiments, the cement sack composition includes an API Class G Portland cement and about 30% fine grade marble by weight substitution of the API Class G Portland cement in the cement sack composition. In some embodiments, the cement sack composition includes an API Class G Portland cement and about 35% fine grade marble by weight substitution of the API Class G Portland cement in the cement sack composition. In some embodiments, the cement sack composition includes an API Class G Portland cement and about 40% fine grade marble by weight substitution of the API Class G Portland cement in the cement sack composition.

In some embodiments, the cement sack composition includes an API Class G MSR grade Portland cement and about 1 to about 30% fine grade marble by weight substitution of the API Class G MSR grade Portland cement in the cement sack composition, such as about 4 to about 27%, about 7 to about 24%, about 10 to about 21%, about 13 to about 18%, about 16 to about 18%, or about 1%, about 5%, about 10%, about 15%, about 20%, about 25%, or about 30% fine grade marble by weight substitution of the API Class G MSR grade Portland cement in the cement sack composition. In some embodiments, the cement sack composition includes an API Class G MSR grade Portland cement and about 5% fine grade marble by weight substitution of the API Class G MSR grade Portland cement in the cement sack composition. In some embodiments, the cement sack composition includes an API Class G MSR grade Portland cement and about 10% fine grade marble by weight substitution of the API Class G MSR grade Portland cement in the cement sack composition. In some embodiments, the cement sack composition includes an API Class G MSR grade Portland cement and about 15% fine grade marble by weight substitution of the API Class G MSR grade Portland cement in the cement sack composition. In some embodiments, the cement sack composition includes an API Class G MSR grade Portland cement and about 20% fine grade marble by weight substitution of the API Class G MSR grade Portland cement in the cement sack composition. In some embodiments, the cement sack composition includes an API Class G MSR grade Portland cement and about 25% fine grade marble by weight substitution of the API Class G MSR grade Portland cement in the cement sack composition. In some embodiments, the cement sack composition includes an API Class G MSR grade Portland cement and about 30% fine grade marble by weight substitution of the API Class G MSR grade Portland cement in the cement sack composition.

In some embodiments, the cement sack composition includes an API Class G HSR grade Portland cement and about 1 to about 40% fine grade marble by weight substitution of the API Class G HSR grade Portland cement in the cement sack composition, such as about 4 to about 37%, about 7 to about 34%, about 10 to about 31%, about 13 to about 28%, about 16 to about 25%, about 19 to about 22%, or about 1%, about 5%, about 10%, about 15%, about 20%, about 25%, about 30%, about 35%, or about 40% fine grade marble by weight substitution of the API Class G HSR grade Portland cement in the cement sack composition. In some embodiments, the cement sack composition includes an API Class G HSR grade Portland cement and about 5% fine grade marble by weight substitution of the API Class G HSR grade Portland cement in the cement sack composition. In some embodiments, the cement sack composition includes an API Class G HSR grade Portland cement and about 10% fine grade marble by weight substitution of the API Class G HSR grade Portland cement in the cement sack composition. In some embodiments, the cement sack composition includes an API Class G HSR grade Portland cement and about 15% fine grade marble by weight substitution of the API Class G HSR grade Portland cement in the cement sack composition. In some embodiments, the cement sack composition includes an API Class G HSR grade Portland cement and about 20% fine grade marble by weight substitution of the API Class G HSR grade Portland cement in the cement sack composition. In some embodiments, the cement sack composition includes an API Class G HSR grade Portland cement and about 25% fine grade marble by weight substitution of the API Class G HSR grade Portland cement in the cement sack composition. In some embodiments, the cement sack composition includes an API Class G HSR grade Portland cement and about 30% fine grade marble by weight substitution of the API Class G HSR grade Portland cement in the cement sack composition. In some embodiments, the cement sack composition includes an API Class G HSR grade Portland cement and about 35% fine grade marble by weight substitution of the API Class G HSR grade Portland cement in the cement sack composition. In some embodiments, the cement sack composition includes an API Class G HSR grade Portland cement and about 40% fine grade marble by weight substitution of the API Class G HSR grade Portland cement in the cement sack composition.

In some embodiments, the cement sack composition includes an API Class H Portland cement and about 0.01 to about 20% coarse grade marble by weight substitution of the API Class H Portland cement in the cement sack composition, such as about 0.5 to about 18%, about 1 to about 16%, about 2 to about 14%, about 3 to about 12%, about 4 to about 10%, about 5 to about 8%, about 6 to about 7%, or about 0.1%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, about 14.5%, about 15.5%, about 16.5%, about 17.5%, about 18.5%, or about 19.5% coarse grade marble by weight substitution of the API Class H Portland cement in the cement sack composition. In some embodiments, the cement sack composition includes an API Class H Portland cement and about 0.1% coarse grade marble by weight substitution of the API Class H Portland cement in the cement sack composition. In some embodiments, the cement sack composition includes an API Class H Portland cement and about 3% coarse grade marble by weight substitution of the API Class H Portland cement in the cement sack composition. In some embodiments, the cement sack composition includes an API Class H Portland cement and about 5% coarse grade marble by weight substitution of the API Class H Portland cement in the cement sack composition. In some embodiments, the cement sack composition includes an API Class H Portland cement and about 7% coarse grade marble by weight substitution of the API Class H Portland cement in the cement sack composition. In some embodiments, the cement sack composition includes an API Class H Portland cement and about 9% coarse grade marble by weight substitution of the API Class H Portland cement in the cement sack composition. In some embodiments, the cement sack composition includes an API Class H Portland cement and about 11% coarse grade marble by weight substitution of the API Class H Portland cement in the cement sack composition. In some embodiments, the cement sack composition includes an API Class H Portland cement and about 13% coarse grade marble by weight substitution of the API Class H Portland cement in the cement sack composition. In some embodiments, the cement sack composition includes an API Class H Portland cement and about 15% coarse grade marble by weight substitution of the API Class H Portland cement in the cement sack composition. In some embodiments, the cement sack composition includes an API Class H Portland cement and about 17% coarse grade marble by weight substitution of the API Class H Portland cement in the cement sack composition. In some embodiments, the cement sack composition includes an API Class H Portland cement and about 19% coarse grade marble by weight substitution of the API Class H Portland cement in the cement sack composition.

In some embodiments, the cement sack composition includes an API Class H MSR grade Portland cement and about 0.01 to about 15% coarse grade marble by weight substitution of the API Class H MSR grade Portland cement in the cement sack composition, such as about 0.5 to about 13%, about 1 to about 11%, about 2 to about 9%, about 3 to about 7%, about 4 to about 5%, or about 0.1%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, or about 14.5% coarse grade marble by weight substitution of the API Class H MSR grade Portland cement in the cement sack composition. In some embodiments, the cement sack composition includes an API Class H MSR grade Portland cement and about 0.1% coarse grade marble by weight substitution of the API Class H MSR grade Portland cement in the cement sack composition. In some embodiments, the cement sack composition includes an API Class H MSR grade Portland cement and about 3% coarse grade marble by weight substitution of the API Class H MSR grade Portland cement in the cement sack composition. In some embodiments, the cement sack composition includes an API Class H MSR grade Portland cement and about 5% coarse grade marble by weight substitution of the API Class H MSR grade Portland cement in the cement sack composition. In some embodiments, the cement sack composition includes an API Class H MSR grade Portland cement and about 7% coarse grade marble by weight substitution of the API Class H MSR grade Portland cement in the cement sack composition. In some embodiments, the cement sack composition includes an API Class H MSR grade Portland cement and about 9% coarse grade marble by weight substitution of the API Class H MSR grade Portland cement in the cement sack composition. In some embodiments, the cement sack composition includes an API Class H MSR grade Portland cement and about 11% coarse grade marble by weight substitution of the API Class H MSR grade Portland cement in the cement sack composition. In some embodiments, the cement sack composition includes an API Class H MSR grade Portland cement and about 13% coarse grade marble by weight substitution of the API Class H MSR grade Portland cement in the cement sack composition. In some embodiments, the cement sack composition includes an API Class H MSR grade Portland cement and about 15% coarse grade marble by weight substitution of the API Class H MSR grade Portland cement in the cement sack composition.

In some embodiments, the cement sack composition includes an API Class H HSR grade Portland cement and about 0.01 to about 20% coarse grade marble by weight substitution of the API Class H HSR grade Portland cement in the cement sack composition, such as about 0.5 to about 18%, about 1 to about 16%, about 2 to about 14%, about 3 to about 12%, about 4 to about 10%, about 5 to about 8%, about 6 to about 7%, or about 0.1%, about 1.5%, about 2.5%, about 3.5%, about 4.5%, about 5.5%, about 6.5%, about 7.5%, about 8.5%, about 9.5%, about 10.5%, about 11.5%, about 12.5%, about 13.5%, about 14.5%, about 15.5%, about 16.5%, about 17.5%, about 18.5%, or about 19.5% coarse grade marble by weight substitution of the API Class H HSR grade Portland cement in the cement sack composition. In some embodiments, the cement sack composition includes an API Class H HSR grade Portland cement and about 0.1% coarse grade marble by weight substitution of the API Class H HSR grade Portland cement in the cement sack composition. In some embodiments, the cement sack composition includes an API Class H HSR grade Portland cement and about 3% coarse grade marble by weight substitution of the API Class H HSR grade Portland cement in the cement sack composition. In some embodiments, the cement sack composition includes an API Class H HSR grade Portland cement and about 5% coarse grade marble by weight substitution of the API Class H HSR grade Portland cement in the cement sack composition. In some embodiments, the cement sack composition includes an API Class H HSR grade Portland cement and about 7% coarse grade marble by weight substitution of the API Class H HSR grade Portland cement in the cement sack composition. In some embodiments, the cement sack composition includes an API Class H HSR grade Portland cement and about 9% coarse grade marble by weight substitution of the API Class H HSR grade Portland cement in the cement sack composition. In some embodiments, the cement sack composition includes an API Class H HSR grade Portland cement and about 11% coarse grade marble by weight substitution of the API Class H HSR grade Portland cement in the cement sack composition. In some embodiments, the cement sack composition includes an API Class H HSR grade Portland cement and about 13% coarse grade marble by weight substitution of the API Class H HSR grade Portland cement in the cement sack composition. In some embodiments, the cement sack composition includes an API Class H HSR grade Portland cement and about 15% coarse grade marble by weight substitution of the API Class H HSR grade Portland cement in the cement sack composition. In some embodiments, the cement sack composition includes an API Class H HSR grade Portland cement and about 17% coarse grade marble by weight substitution of the API Class H HSR grade Portland cement in the cement sack composition. In some embodiments, the cement sack composition includes an API Class H HSR grade Portland cement and about 19% coarse grade marble by weight substitution of the API Class H HSR grade Portland cement in the cement sack composition.

In some embodiments, the cement sack composition includes an API Class H Portland cement and about 0.01 to about 35% medium grade marble by weight substitution of the API Class H Portland cement in the cement sack composition, such as about 1 to about 32%, about 4 to about 29%, about 7 to about 26%, about 10 to about 23%, about 13 to about 20%, about 16 to about 17%, or about 0.5%, about 2.5%, about 7.5%, about 12.5%, about 17.5%, about 22.5%, about 27.5%, or about 32.5% medium grade marble by weight substitution of the API Class H Portland cement in the cement sack composition. In some embodiments, the cement sack composition includes an API Class H Portland cement and about 1% medium grade marble by weight substitution of the API Class H Portland cement in the cement sack composition. In some embodiments, the cement sack composition includes an API Class H Portland cement and about 5% medium grade marble by weight substitution of the API Class H Portland cement in the cement sack composition. In some embodiments, the cement sack composition includes an API Class H Portland cement and about 10% medium grade marble by weight substitution of the API Class H Portland cement in the cement sack composition. In some embodiments, the cement sack composition includes an API Class H Portland cement and about 15% medium grade marble by weight substitution of the API Class H Portland cement in the cement sack composition. In some embodiments, the cement sack composition includes an API Class H Portland cement and about 20% medium grade marble by weight substitution of the API Class H Portland cement in the cement sack composition. In some embodiments, the cement sack composition includes an API Class H Portland cement and about 25% medium grade marble by weight substitution of the API Class H Portland cement in the cement sack composition. In some embodiments, the cement sack composition includes an API Class H Portland cement and about 30% medium grade marble by weight substitution of the API Class H Portland cement in the cement sack composition. In some embodiments, the cement sack composition includes an API Class H Portland cement and about 35% medium grade marble by weight substitution of the API Class H Portland cement in the cement sack composition.

In some embodiments, the cement sack composition includes an API Class H MSR grade Portland cement and about 0.01 to about 25% medium grade marble by weight substitution of the API Class H MSR grade Portland cement in the cement sack composition, such as about 1 to about 23%, about 4 to about 20%, about 7 to about 17%, about 10 to about 14%, about 12 to about 13%, or about 0.5%, about 2.5%, about 7.5%, about 12.5%, about 17.5%, or about 22.5% medium grade marble by weight substitution of the API Class H MSR grade Portland cement in the cement sack composition. In some embodiments, the cement sack composition includes an API Class H MSR grade Portland cement and about 1% medium grade marble by weight substitution of the API Class H MSR grade Portland cement in the cement sack composition. In some embodiments, the cement sack composition includes an API Class H MSR grade Portland cement and about 5% medium grade marble by weight substitution of the API Class H MSR grade Portland cement in the cement sack composition. In some embodiments, the cement sack composition includes an API Class H MSR grade Portland cement and about 10% medium grade marble by weight substitution of the API Class H MSR grade Portland cement in the cement sack composition. In some embodiments, the cement sack composition includes an API Class H MSR grade Portland cement and about 15% medium grade marble by weight substitution of the API Class H MSR grade Portland cement in the cement sack composition. In some embodiments, the cement sack composition includes an API Class H MSR grade Portland cement and about 20% medium grade marble by weight substitution of the API Class H MSR grade Portland cement in the cement sack composition. In some embodiments, the cement sack composition includes an API Class H MSR grade Portland cement and about 25% medium grade marble by weight substitution of the API Class H MSR grade Portland cement in the cement sack composition.

In some embodiments, the cement sack composition includes an API Class H HSR grade Portland cement and about 0.01 to about 35% medium grade marble by weight substitution of the API Class H HSR grade Portland cement in the cement sack composition, such as about 1 to about 32%, about 4 to about 29%, about 7 to about 26%, about 10 to about 23%, about 13 to about 20%, about 16 to about 17%, or about 0.5%, about 2.5%, about 7.5%, about 12.5%, about 17.5%, about 22.5%, about 27.5%, or about 32.5% medium grade marble by weight substitution of the API Class H HSR grade Portland cement in the cement sack composition. In some embodiments, the cement sack composition includes an API Class H HSR grade Portland cement and about 1% medium grade marble by weight substitution of the API Class H HSR grade Portland cement in the cement sack composition. In some embodiments, the cement sack composition includes an API Class H HSR grade Portland cement and about 5% medium grade marble by weight substitution of the API Class H HSR grade Portland cement in the cement sack composition. In some embodiments, the cement sack composition includes an API Class H HSR grade Portland cement and about 10% medium grade marble by weight substitution of the API Class H HSR grade Portland cement in the cement sack composition. In some embodiments, the cement sack composition includes an API Class H HSR grade Portland cement and about 15% medium grade marble by weight substitution of the API Class H HSR grade Portland cement in the cement sack composition. In some embodiments, the cement sack composition includes an API Class H HSR grade Portland cement and about 20% medium grade marble by weight substitution of the API Class H HSR grade Portland cement in the cement sack composition. In some embodiments, the cement sack composition includes an API Class H HSR grade Portland cement and about 25% medium grade marble by weight substitution of the API Class H HSR grade Portland cement in the cement sack composition. In some embodiments, the cement sack composition includes an API Class H HSR grade Portland cement and about 30% medium grade marble by weight substitution of the API Class H HSR grade Portland cement in the cement sack composition. In some embodiments, the cement sack composition includes an API Class H HSR grade Portland cement and about 35% medium grade marble by weight substitution of the API Class H HSR grade Portland cement in the cement sack composition.

In some embodiments, the cement sack composition includes an API Class H Portland cement and about 1 to about 45% fine grade rmarble by weight substitution of the API Class H Portland cement in the cement sack composition, such as about 5 to about 40%, about 10 to about 35%, about 15 to about 30%, about 20 to about 25%, or about 3%, about 5%, about 7%, about 9%, about 11%, about 13%, about 15%, about 17%, about 19%, about 21%, about 23%, about 25%, about 27%, about 29%, about 31%, about 33%, about 35%, about 37%, about 39%, about 41%, about 43%, or about 45% fine grade marble by weight substitution of the API Class H Portland cement in the cement sack composition. In some embodiments, the cement sack composition includes an API Class H Portland cement and about 5% fine grade marble by weight substitution of the API Class H Portland cement in the cement sack composition. In some embodiments, the cement sack composition includes an API Class H Portland cement and about 10% fine grade marble by weight substitution of the API Class H Portland cement in the cement sack composition. In some embodiments, the cement sack composition includes an API Class H Portland cement and about 15% fine grade marble by weight substitution of the API Class H Portland cement in the cement sack composition. In some embodiments, the cement sack composition includes an API Class H Portland cement and about 20% fine grade marble by weight substitution of the API Class H Portland cement in the cement sack composition. In some embodiments, the cement sack composition includes an API Class H Portland cement and about 25% fine grade marble by weight substitution of the API Class H Portland cement in the cement sack composition. In some embodiments, the cement sack composition includes an API Class H Portland cement and about 30% fine grade marble by weight substitution of the API Class H Portland cement in the cement sack composition. In some embodiments, the cement sack composition includes an API Class H Portland cement and about 35% fine grade marble by weight substitution of the API Class H Portland cement in the cement sack composition. In some embodiments, the cement sack composition includes an API Class H Portland cement and about 40% fine grade marble by weight substitution of the API Class H Portland cement in the cement sack composition. In some embodiments, the cement sack composition includes an API Class H Portland cement and about 45% fine grade marble by weight substitution of the API Class H Portland cement in the cement sack composition.

In some embodiments, the cement sack composition includes an API Class H MSR grade Portland cement and about 1 to about 35% fine grade marble by weight substitution of the API Class H MSR grade Portland cement in the cement sack composition, such as about 5 to about 30%, about 10 to about 25%, about 15 to about 20%, or about 3%, about 5%, about 7%, about 9%, about 11%, about 13%, about 15%, about 17%, about 19%, about 21%, about 23%, about 25%, about 27%, about 29%, about 31%, about 33%, or about 35% fine grade marble by weight substitution of the API Class H MSR grade Portland cement in the cement sack composition. In some embodiments, the cement sack composition includes an API Class H MSR grade Portland cement and about 5% fine grade marble by weight substitution of the API Class H MSR grade Portland cement in the cement sack composition. In some embodiments, the cement sack composition includes an API Class H MSR grade Portland cement and about 10% fine grade marble by weight substitution of the API Class H MSR grade Portland cement in the cement sack composition. In some embodiments, the cement sack composition includes an API Class H MSR grade Portland cement and about 15% fine grade marble by weight substitution of the API Class H MSR grade Portland cement in the cement sack composition. In some embodiments, the cement sack composition includes an API Class H MSR grade Portland cement and about 20% fine grade marble by weight substitution of the API Class H MSR grade Portland cement in the cement sack composition. In some embodiments, the cement sack composition includes an API Class H MSR grade Portland cement and about 25% fine grade marble by weight substitution of the API Class H MSR grade Portland cement in the cement sack composition. In some embodiments, the cement sack composition includes an API Class H MSR grade Portland cement and about 30% fine grade marble by weight substitution of the API Class H MSR grade Portland cement in the cement sack composition. In some embodiments, the cement sack composition includes an API Class H MSR grade Portland cement and about 35% fine grade marble by weight substitution of the API Class H MSR grade Portland cement in the cement sack composition.

In some embodiments, the cement sack composition includes an API Class H HSR grade Portland cement and about 1 to about 45% fine grade marble by weight substitution of the API Class H HSR grade Portland cement in the cement sack composition, such as about 5 to about 40%, about 10 to about 35%, about 15 to about 30%, about 20 to about 25%, or about 3%, about 5%, about 7%, about 9%, about 11%, about 13%, about 15%, about 17%, about 19%, about 21%, about 23%, about 25%, about 27%, about 29%, about 31%, about 33%, about 35%, about 37%, about 39%, about 41%, about 43%, or about 45% fine grade marble by weight substitution of the API Class H HSR grade Portland cement in the cement sack composition. In some embodiments, the cement sack composition includes an API Class H HSR grade Portland cement and about 5% fine grade marble by weight substitution of the API Class H HSR grade Portland cement in the cement sack composition. In some embodiments, the cement sack composition includes an API Class H HSR grade Portland cement and about 10% fine grade marble by weight substitution of the API Class H HSR grade Portland cement in the cement sack composition. In some embodiments, the cement sack composition includes an API Class H HSR grade Portland cement and about 15% fine grade marble by weight substitution of the API Class H HSR grade Portland cement in the cement sack composition. In some embodiments, the cement sack composition includes an API Class H HSR grade Portland cement and about 20% fine grade marble by weight substitution of the API Class H HSR grade Portland cement in the cement sack composition. In some embodiments, the cement sack composition includes an API Class H HSR grade Portland cement and about 25% fine grade marble by weight substitution of the API Class H HSR grade Portland cement in the cement sack composition. In some embodiments, the cement sack composition includes an API Class H HSR grade Portland cement and about 30% fine grade marble by weight substitution of the API Class H HSR grade Portland cement in the cement sack composition. In some embodiments, the cement sack composition includes an API Class H HSR grade Portland cement and about 35% fine grade marble by weight substitution of the API Class H HSR grade Portland cement in the cement sack composition. In some embodiments, the cement sack composition includes an API Class H HSR grade Portland cement and about 40% fine grade marble by weight substitution of the API Class H HSR grade Portland cement in the cement sack composition. In some embodiments, the cement sack composition includes an API Class H HSR grade Portland cement and about 45% fine grade marble by weight substitution of the API Class H HSR grade Portland cement in the cement sack composition.

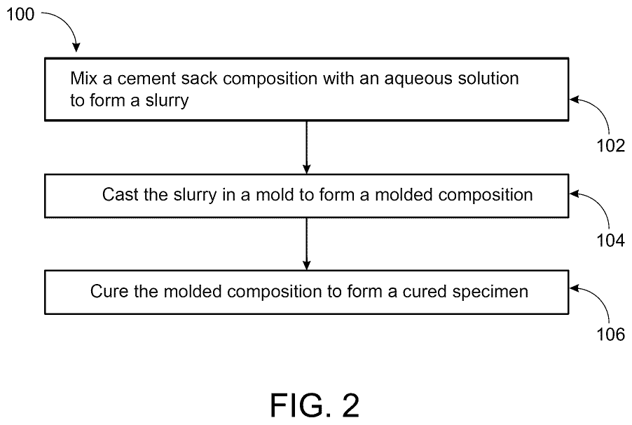

FIG. 2 illustrates a flow chart of a method 100 of producing a cured specimen. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes mixing the cement sack composition with an aqueous solution to form a a slurry. In some embodiments, the cement sack composition includes a hydraulic cement selected from the group consisting of an API Class A Portland cement, an API Class C Portland cement, an API Class G Portland cement, an API Class H Portland cement, and combinations thereof; and an additive in an amount of about 0.01 to about 50% by weight substitution of the hydraulic cement in the cement sack composition. In some embodiments, the additive is selected from the group consisting of fine grade marble, medium grade marble, coarse grade marble, and combinations thereof.

In some embodiments, if needed to set, the cement sack composition, is typically added to water, which may further contain other chemical additives and ad-mix solutions to form the aqueous solution. The water may be classified using a base of fresh water, sea water, brines, acidic-based, alkaline-based, or any combination thereof. The cement sack composition is typically added into the aqueous solution after the hydraulic cement is mixed with the other components/ingredients, for example, marble, and it is then ready to be hardened or set.

In some embodiments, a weight ratio of the cement sack composition to the aqueous solution is about 3:1 to about 1:1, such as about 2.8:1 to about 1.4:1, such as about 2.6 to 1 to about 1.8:1, such as about 2.4:1 to about 2:1, about 2.9:1, about 2.8:1, about 2.7:1, about 2.6:1, about 2.5:1, about 2.4:1, about 2.3:1, about 2.2:1, about 2.1:1, about 2:1, about 1.9:1, or about 1.8:1. In some embodiments, the weight ratio of the cement sack composition to the aqueous solution is about 2.3:1. In some embodiments, the weight ratio of the cement sack composition to the aqueous solution is about 2.2:1. In some embodiments, the weight ratio of the cement sack composition to the aqueous solution is about 2.1:1. In some embodiments, the weight ratio of the cement sack composition to the aqueous solution is about 2:1.

At step 104, the method 100 includes casting the slurry in a mold to form a molded composition. The casting may be performed by any of the conventional methods known in the art.

At step 106, the method 100 includes curing the molded composition by following API 10B-2 and 10A to form the cured specimen. The slurry is tested per the recommended practice for testing well cements unless specified otherwise. See API RP 10B-2, Recommended Practice for Testing Well Cements. 2024. Third Edition by API, which is incorporated herein by reference in its entirety. API Specifications 10B-2 outlines the recommended practices for slurry preparation, conditioning, and testing various properties of oil-well cement. Following API specifications makes sure that the results obtained are reproducible in the tested conditions. The crystalline structures of the cured specimens may be characterized by X-ray Fluorescence (XRF).

In some embodiments, the cured specimen has an ultrasonic compressive strength (UCS) of 1750 to 2150 psi tested at 24 hours by following API 10B using an ultrasonic cement analyzer, such as about 1800 to about 2100 psi, about 1850 to about 2050 psi, about 1900 to about 2000 psi, about 1950 to about 2000 psi tested at 24 hours. In some embodiments, the cured specimen has an ultrasonic compressive strength of about 1787 psi tested at 24 hours. In some embodiments, the cured specimen has an ultrasonic compressive strength of about 1924 psi tested at 24 hours. In some embodiments, the cured specimen has an ultrasonic compressive strength of about 2101 psi tested at 24 hours.

In some embodiments, the cured specimen has a strength of about 1850 to about 2650 psi tested at 24 hours by following API 10A, such as about 1900 to about 2600 psi, about 1950 to about 2550 psi, about 2000 to about 2500 psi, about 2050 to about 2450 psi, about 2100 to about 2400 psi, about 2150 to about 2350 psi, or about 2200 to about 2300 psi. In some embodiments, the cured specimen has a strength of about 1910 psi tested at 24 hours. In some embodiments, the cured specimen has a strength of about 2192 psi tested at 24 hours. In some embodiments, the cured specimen has a strength of about 2577 psi tested at 24 hours.

In some embodiments, the cured specimen made from the cement sack composition can meet or exceed one or more physical performance specifications as described in API Specification 10A-2019 (Cements and Materials for Well Cementing, American Petroleum Institute (API) Specification 10A, Twenty-Fifth Edition, —2019), which is incorporated herein by reference in its entirety. In some embodiments, the one or more physical performance includes, but is not limited to, mixing time, free fluid, sedimentation, rheology, thickening time, destructive strength, ultrasonic compressive strength, and XRF chemical analysis.

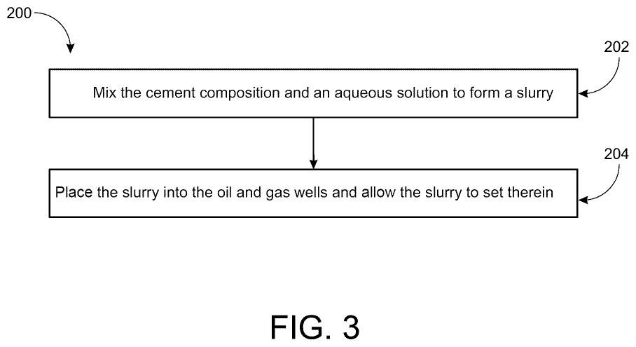

FIG. 3 illustrates a flow chart of a method 200 of cementing oil and gas wells. The order in which the method 200 is described is not intended to be construed as a limitation, and any number of the described method steps can be combined in any order to implement the method 200. Additionally, individual steps may be removed or skipped from the method 200 without departing from the spirit and scope of the present disclosure.

At step 202, the method 200 includes mixing a cement sack composition and an aqueous solution (e.g., a chemical ad-mixture solution) to form a slurry. In some embodiments, the cement sack composition includes a hydraulic cement selected from the group consisting of an API Class A Portland cement, an API Class C Portland cement, an API Class G Portland cement, an API Class H Portland cement, and combinations thereof; and an additive in an amount of about 0.01 to about 50% by weight substitution in the cement sack composition. In some embodiments, the additive is selected from the group consisting of fine grade marble, medium grade marble, coarse grade marble, and combinations thereof.

In some embodiments, the aqueous solution includes a retarder surfactant, a dispersant, a fluid loss control agent, a viscosity modifier, a defoaming agent, a pH modifier, and water.

The dispersant may include, but is not limited to, a polycarboxylate, e.g. a polycarboxylate derivative with polyethylene oxide side chains, a polycarboxylate ether (PCE) superplasticizer, such as the Glenium. Polycarboxylate ether-based superplasticizers may allow water reduction at a relatively low dosage, thereby providing good particle dispersion in the wet slurry. Polycarboxylate ether-based superplasticizers are composed of a methoxy-polyethylene glycol copolymer (side chain) grafted with methacrylic acid copolymer (main chain). Exemplary plasticizers that may be used in addition to, or in lieu of a polycarboxylate ether based superplasticizer include, but are not limited to, alkyl citrates, sulfonated naphthalene, sulfonated alene, sulfonated melamine, lignosulfonates, calcium lignosulfonate, naphthalene lignosulfonate, polynaphthalenesulfonates, formaldehyde, sulfonated naphthalene formaldehyde condensate, acetone formaldehyde condensate, polymelaminesulfonates, sulfonated melamine formaldehyde condensate, polycarbonate, other polycarboxylates, other polycarboxylate derivatives comprising polyethylene oxide side chains, and the like and mixtures thereof.

The deforming agent may include, but is not limited to, 2-octanol, oleic acid, paraffinic waxes, amide waxes, sulfonated oils, organic phosphates, silicone oils, mineral oils, and dimethylpolysiloxane. The defoaming agent may be dimethyl silicone polymer or polyoxy propylene glycerin ether.

The retarder may include, but is not limited to, calcium chelating agents, carboxylic acids and salts thereof, polysaccharides and derivatives thereof, phosphonates, lignosulfonates, phosphates, borates, or salts of lead, zinc, copper, arsenic, and antimony.

The fluid loss control agent may include, but is not limited to, 2-acrylamido-2-methylpropane sulfonic acid polymer or polyvinyl alcohol based polymer.

The viscosity modifier may include, but is not limited to, organic acid, and carboxymethylcellulose.

At step 204, the method 200 includes placing the slurry into the oil and gas wells and allowing the slurry to set therein.

### EXAMPLES

### Example 1. Physical Properties of Marbles

The physical properties of fine grade marble, medium grade marble, and coarse grade marble were tested according to corresponding methods and specifications, including particle size, surface area as determined by ASTM E3340-22 (Standard Guide for Development of Laser Diffraction Particle Size Analysis Methods for Powder Materials, ASTM E3340-22, which is incorporated herein by reference in its entirety), and specific gravity as determined by ASTM D5550-23 (Standard Test Method for Specific Gravity of Soil Solids by Gas Pycnometer, ASTM D5550-23, which is incorporated herein by reference in its entirety). The corresponding results are shown in Table 1 below.

TABLE 1
Physical properties of fine grade marble, medium
grade marble, and coarse grade marble

| Test | UOM | Fine | Medium | Coarse |
|---|---|---|---|---|
| Density | SG | 2.89 | 2.89 | 2.89 |
| Surface Area | m²/kg | 810.4 | 230.9 | 56.87 |
| D₉₀ | μm | 61.5 | 328 | 886 |
| D₅₀ | μm | 16.9 | 152 | 568 |
| D₁₀ | μm | 2.75 | 11.4 | 208 |

### Example 2. Chemical Properties of Marbles

The chemical properties of fine grade marble, medium grade marble, and coarse grade marble were tested according to methods and specifications as described in. ASTM E3294-23 (Standard Guide for Forensic Analysis of Geological Materials by Powder X-Ray Diffraction, ASTM E3294-23, which is incorporated herein by reference in its entirety). The corresponding results are shown in Table 2 below.

TABLE 1
Chemical properties of fine grade marble, medium
grade marble, and coarse grade marble

| Mineral | | Fine | Medium | Coarse |
|---|---|---|---|---|
| phase | Formula | (wt %) | (wt %) | (wt %) |
| Dolomite | CaMg(CO₃)₂ | 89.1 | 93.7 | 86.0 |
| Calcite | CaCO₃ | 10.9 | 6.3 | 14.0 |

### Example 3. Equivalent Sack

The substitution process is expressed using a ratio nomenclature. For example, a 15% dolomitic substitution of 100% API cement is represented as a 15:85 marble:cement equivalent sack cement sack composition. The equivalent sack calculation is based on a standard sack weight of 94 pounds for 100% API cement and a specific gravity (SG) value for the API cement, which in this example is 3.24. The reduced API cement requirement is calculated based on the substitution ratio. For a 15% substitution, the API cement content is reduced to 85% of the total sack weight, resulting in 79.9 pounds per sack with an adjusted SG contribution of 2.754.

The marble substitution is determined by using a sack weight of 50 pounds and a specific gravity of 2.89 for the marble component. With a 15% substitution factor applied, the marble contribution is calculated as 7.5 pounds per sack with a specific gravity contribution of 0.434. Accordingly, the combined contributions from the API cement and marble result in an equivalent sack weight of 87.4 pounds per sack with an overall SG of 3.19. These calculated values form the basis for determining the absolute volume requirements for cement slurry design and bulk plant operations.

TABLE 3
Equivalent sack

| Composition | 15% Marble | | 85% Cement | | Equivalent Sack | |
|---|---|---|---|---|---|---|
| 15:85 marble:cement | 7.5 lb | 0.434 SG | 79.9 lb | 2.754 SG | 87.4 lb | 3.19 SG |

### Example 3. Cement Mixing

Exemplary cement sack compositions for an equivalent sack were prepared as shown in Table 4 below. 85 parts of API Class G Portland cement were mixed with 15 parts of marble to create the corresponding equivalent sack cement sack composition. The water requirement was adjusted accordingly due to the addition of marble to achieve the same density.

TABLE 4
Cement sack compositions

| | | Class G | 15:85 | 15:85 | 15:85 |
|---|---|---|---|---|---|
| Design | UOM | (neat) | (fine) | (medium) | (coarse) |
| Cement Density | ppg | 15.8 | 15.8 | 15.8 | 15.8 |
| Water Requirement | gps | 5.233 | 4.794 | 4.794 | 4.794 |
| Cement Yield | cfs | 1.165 | 1.078 | 1.078 | 1.078 |

ppg = pounds per gallon,
gps = gallons per sack,
cfs = cubic foot per sack

Cement mixing times for the cement sack compositions range from about 14 seconds to about 18 seconds as illustrated in Table 5, depending on the particle size variation of fine, medium, and coarse grade marble, following API 10A for slurry preparation.

TABLE 5
API mixing time

| | Class G | 15:85 | 15:85 | 15:85 |
|---|---|---|---|---|
| | (neat) | (fine) | (medium) | (coarse) |
| Mixing time (sec) | 17 | 18 | 15 | 14 |

Free fluid tests for the cement sack compositions range from about 2.23% to about 6.22% according to methods and specifications as described in API 10A,

TABLE 6
API free fluid test

| | Class G | 15:85 | 15:85 | 15:85 | |
|---|---|---|---|---|---|
| | (neat) | (fine) | (medium) | (coarse) | API Spec 10 |
| Free fluid (%) | 3.48 | 2.23 | 5.47 | 6.22 | 5.90 max |

API sedimentation results for the exemplary cement sack compositions were shown in Table 7 following API 10B-2.

TABLE 7
API sedimentation results

| | | Class G | 15:85 | 15:85 | 15:85 |
|---|---|---|---|---|---|
| Segment | UOM | (neat) | (fine) | (medium) | (coarse) |
| Top | ppg | 15.7872 | 15.7974 | 15.5459 | 15.4194 |
| 1 | ppg | 15.7991 | 15.7976 | 15.7270 | 15.5822 |
| 2 | ppg | 15.7962 | 15.7978 | 15.7533 | 15.6544 |
| 3 | ppg | 15.7986 | 15.7980 | 15.8421 | 15.8617 |
| 4 | ppg | 15.7994 | 15.7980 | 15.9064 | 16.0133 |
| Bottom | ppg | 15.8006 | 15.7979 | 15.9257 | 16.1502 |
| Δ | ppg | 0.0134 | 0.0006 | 0.3798 | 0.7308 |

The rheological behavior of the exemplary cement sack compositions in water was tested at 80° F. and 125° F., respectively. The rheology profiles of the cement sack composition-water mixtures are shown in Tables 8 and 9 following API 10B-2.

TABLE 8
API rheology test at 80° F.

| 80 deg F. | Class G (neat) | | | 15:85 (fine) | | | 15:85 (medium) | | | 15:85 (coarse) | | |
|---|---|---|---|---|---|---|---|---|---|---|---|---|
| RPM | Up | Down | Avg | Up | Down | Avg | Up | Down | Avg | Up | Down | Avg |
| 300 | 65 | | 65 | 85 | | 85 | 68 | | 68 | 52 | | 52 |
| 200 | 53 | 60 | 57 | 72 | 74 | 73 | 37 | 64 | 51 | 37 | 47 | 42 |
| 100 | 38 | 47 | 43 | 54 | 58 | 56 | 31 | 48 | 40 | 31 | 35 | 33 |
| 60 | 32 | 41 | 37 | 46 | 51 | 49 | 28 | 28 | 28 | 28 | 29 | 28 |
| 30 | 26 | 34 | 30 | 38 | 44 | 41 | 22 | 26 | 24 | 22 | 25 | 23 |
| 6 | 15 | 28 | 22 | 19 | 21 | 20 | 11 | 15 | 13 | 12 | 31 | 22 |
| 3 | 8 | 12 | 10 | 11 | 15 | 13 | 6 | 10 | 8 | 7 | 9 | 8 |

TABLE 9
API rheology test at 125° F.

| 125 deg F. | Class G (neat) | | | 15:85 (fine) | | | 15:85 (medium) | | | 15:85 (coarse) | | |
|---|---|---|---|---|---|---|---|---|---|---|---|---|
| RPM | Up | Down | Avg | Up | Down | Avg | Up | Down | Avg | Up | Down | Avg |
| 300 | 114 | | 114 | 134 | | 134 | 66 | | 66 | 64 | | 64 |
| 200 | 99 | 97 | 98 | 117 | 115 | 116 | 57 | 59 | 58 | 55 | 59 | 57 |
| 100 | 79 | 78 | 79 | 94 | 93 | 94 | 46 | 48 | 47 | 44 | 46 | 45 |
| 60 | 70 | 68 | 69 | 82 | 83 | 83 | 41 | 42 | 42 | 42 | 42 | 42 |
| 30 | 55 | 53 | 54 | 62 | 60 | 61 | 38 | 36 | 37 | 34 | 36 | 35 |
| 6 | 20 | 21 | 21 | 19 | 23 | 21 | 15 | 16 | 16 | 14 | 15 | 15 |
| 3 | 13 | 11 | 12 | 14 | 14 | 14 | 10 | 11 | 11 | 9 | 11 | 10 |

The thickening time of the exemplary cement sack compositions in water was tested at ambient temperature. The results are shown in Table 10 following API 10A.

TABLE 10
API thickening time

| | Class G | 15:85 | 15:85 | 15:85 | |
|---|---|---|---|---|---|
| | (neat) | (fine) | (medium) | (coarse) | API Spec 10 |
| Thickening | 109 | 128 | 125 | 120 | 90 min, 120 max |
| time (min) | | | | | |

The 8-hr strength of cured specimens made from the mixture of exemplary cement sack compositions and water was tested according to the methods specified in API 10A. The results are shown in Table 11.

TABLE 11
8-hr strength results

| | Class G | 15:85 | 15:85 | 15:85 | |
|---|---|---|---|---|---|
| | (neat) | (fine) | (medium) | (coarse) | API Sec 10 |
| Strength at 100 | 452 | 362 | 238 | 166 | 300 min |
| def F (psi) | | | | | |
| Strength at 140 | 1642 | 89 | 732 | 616 | 1500 min |
| def F (psi) | | | | | |

Chemical analysis of pre-hydrated sacks, including the mixture of exemplary cement sack compositions and water, was performed using XRF. The results are shown in Table 12 following methods described in API 10A.

TABLE 12
Chemical analysis of pre-hydrated sacks

| | | Class G | 15:85 | 15:85 | 15:85 | |
|---|---|---|---|---|---|---|
| Element | UOM | (neat) | (fine) | (medium) | (coarse) | API Spec 10A |
| MgO | % | 1.99 | 1.88 | 1.86 | 1.85 | 6.0 max |
| Al₂O₃ | % | 1.61 | 1.85 | 2.15 | 2.12 | |
| SiO₂ | % | 19.03 | 19.13 | 19.22 | 19.12 | |
| SO₃ | % | 2.20 | 2.21 | 2.22 | 2.20 | 3.0 max |
| LOI | % | 0.95 | 2.16 | 2.68 | 2.84 | 3.0 max |
| Insoluble residue | % | 0.58 | 0.61 | 0.62 | 0.64 | 0.75 max |
| Na₂O | % | 0.35 | 0.33 | 0.31 | 0.30 | 0.75 max |
| CaO | % | 67.85 | 74.23 | 69.44 | 71.56 | |
| Fe₂O₃ | % | 5.89 | 5.68 | 6.20 | 6.00 | |
| CaCO₃ | % | 0.00 | 2.20 | 1.10 | 1.00 | |
| C₃S | % | 49.20 | 49.52 | 48.98 | 49.25 | 48 min, 65 max |
| C₂S | % | 18.67 | 18.61 | 18.65 | 18.66 | |
| C₃A | % | 0.60 | 0.80 | 0.8 | 0.8 | 3.0 max |
| C₄AF | % | 16.46 | 16.45 | 16.39 | 16.38 | |
| C₄AF + 2 (C₃A) | % | 17.66 | 18.05 | 17.99 | 17.98 | 24 max |

Chemical analysis of post-hydrated sacks was also tested using XRF. The results are shown in Table 13 using same methods as referenced in API 10A.

TABLE 13
Chemical analysis of post-hydrated sacks

| | | Class G | 15:85 | 15:85 | 15:85 |
|---|---|---|---|---|---|
| Element | UOM | (neat) | (fine) | (medium) | (coarse) |
| MgO | % | 1.99 | 1.88 | 1.87 | 1.85 |
| Al₂O₃ | % | 1.76 | 1.92 | 2.21 | 2.21 |
| SiO₂ | % | 19.09 | 19.16 | 19.32 | 19.23 |
| SO₃ | % | 2.21 | 2.22 | 2.22 | 2.23 |
| LOI | % | — | — | — | — |
| Insoluble residue | % | — | — | — | — |
| Na₂O | % | — | — | — | — |
| CaO | % | 68.46 | 72.56 | 70.52 | 72.58 |
| Fe₂O₃ | % | 5.82 | 8.69 | 5.99 | 5.84 |
| CaCO₃ | % | 0.00 | 8.50 | 8.40 | 8.20 |
| C₃S | % | 50.25 | 50.35 | 50.45 | 50.43 |
| C₂S | % | 18.68 | 18.64 | 18.69 | 18.68 |
| C₃A | % | 0.62 | 0.79 | 0.79 | 0.79 |
| C₄AF | % | Trace | Trace | Trace | Trace |
| Portlandite | % | 36.00 | 23.80 | 24.50 | 28.30 |

The 24-hr strength and 24-hr ultrasonic compressive strength of cured specimens made from the mixture of exemplary cement sack compositions and water were tested according to the methods specified in API 10A (strength) and API 10B-2 (ultrasonic compressive strength using an UCA or ultrasonic cement analyzer). The results are shown in Tables 14 and 15, respectively.

TABLE 14
24-hr strength results

| | Class G | 15:85 | 15:85 | 15:85 | |
|---|---|---|---|---|---|
| | (neat) | (fine) | (medium) | (coarse) | API Sec 10 |
| Strength at 140 | 2897 | 2577 | 2192 | 1910 | — |
| def F (psi) | | | | | |

TABLE 15
24-hr UCA strength results

| | Class G | 15:85 | 15:85 | 15:85 | |
|---|---|---|---|---|---|
| | (neat) | (fine) | (medium) | (coarse) | API Sec 10 |
| Strength at 140 | 2388 | 2101 | 1924 | 1787 | — |
| def F (psi) | | | | | |

### EMBODIMENTS

Certain embodiments of this disclosure can be implemented as a cement sack composition. The cement sack composition includes a hydraulic cement selected from the group consisting of an API Class A Portland cement, an API Class C Portland cement, an API Class G Portland cement, an API Class H Portland cement, and combinations thereof; and an additive in an amount of about 0.01 to about 50% by weight of substitution of the hydraulic cement in the cement sack composition. The additive is selected from the group consisting of fine (grade) marble, medium (grade) marble, coarse (grade) marble, and combinations thereof. A cured specimen made from the equivalent cement sack composition can meet or exceed one or more physical performance specifications as described in API 10A.

An aspect combinable with any other aspect can include the following features. The cement sack composition includes an API Class A Portland cement, and about 1 to about 20% coarse grade marble by weight substitution of the API Class A Portland cement in the cement sack composition.

An aspect combinable with any other aspect can include the following features. The cement sack composition includes an API Class A Portland cement, and about 0.01 to about 5% medium grade marble by weight substitution of the API Class A Portland cement in the cement sack composition.

An aspect combinable with any other aspect can include the following features. The cement sack composition includes an API Class C Portland cement, and about 0.1 to about 15% coarse grade marble by weight substitution of the API Class C Portland cement in the cement sack composition.

An aspect combinable with any other aspect can include the following features. The cement sack composition includes an API Class C Portland cement, and about 0.01 to about 5% medium grade marble by weight substitution of the API Class C Portland cement in the cement sack composition.

An aspect combinable with any other aspect can include the following features. The cement sack composition includes an API Class G Portland cement, and about 0.01 to about 15% coarse grade marble by weight substitution of the API Class G Portland cement in the cement sack composition.

An aspect combinable with any other aspect can include the following features. The cement sack composition includes an API Class G Portland cement, and about 0.01 to about 30% medium grade marble by weight substitution of the API Class G Portland cement in the cement sack composition

An aspect combinable with any other aspect can include the following features. The cement sack composition includes an API Class G Portland cement, and about 1 to about 40% fine grade marble by weight substitution of the API Class G Portland cement in the cement sack composition.

An aspect combinable with any other aspect can include the following features. The cement sack composition includes an API Class H Portland cement, and about 0.01 to about 20% coarse grade marble by weight substitution of the API Class H Portland cement in the cement sack composition.

An aspect combinable with any other aspect can include the following features. The cement sack composition includes an API Class H Portland cement, and about 0.01 to about 35% medium grade marble by weight substitution of the API Class H Portland cement in the cement sack composition.

An aspect combinable with any other aspect can include the following features. The cement sack composition includes an API Class H Portland cement, and about 1 to about 45% fine grade marble by weight substitution of the API Class H Portland cement in the cement sack composition.

An aspect combinable with any other aspect can include the following features. The fine grade marble of the cement sack composition is in the form of powders having a 10% cumulative particle size (D₁₀) of from about 1 to about 5 micrometers (μm), a 50% cumulative particle size (D₅₀) of from about 8 to about 32 μm, and a 90% cumulative particle size (D₉₀) of from about 32 to about 90 μm.

An aspect combinable with any other aspect can include the following features. The medium grade marble of the cement sack composition is in the form of regular-shaped particles having a D10 particle size of from about 5 to about 25 μm, a D50 particle size of from about 100 to about 200 μm, a D90 particle size of 250 to about 410 μm.

An aspect combinable with any other aspect can include the following features. The coarse grade marble of the cement sack composition is in the form of irregular-shaped particles having a D₁₀ particle size of from about 100 to about 300 μm, a D₅₀ particle size of from about 350 to about 750 μm, a D₉₀ particle size of 600 to about 1100 μm.

An aspect combinable with any other aspect can include the following features. The fine grade marble includes about 87.1 to about 91.1 wt. % of dolomite (CaMg(CO₃)₂), and about 8.9 to about 12.9 wt. % of calcite (CaCO₃), each wt. % based on a total weight of the fine grade marble.

An aspect combinable with any other aspect can include the following features. The medium grade marble includes about 91.7 to about 95.7 wt. % of dolomite, and about 4.3 to about 8.3 wt. % of calcite, each wt. % based on a total weight of the medium grade marble. An aspect combinable with any other aspect can include the following features. The coarse grade marble includes about 84 to about 88 wt. % of dolomite, and about 12 to about 16 wt. % of calcite, each wt. % based on a total weight of the coarse grade marble.

Certain embodiments of this disclosure can be implemented as methods of producing a cured specimen. The method includes mixing the cement sack composition with an aqueous solution to form a slurry. The slurry is casted in a mold to form a molded composition. The molded composition is cured to form the cured specimen by following API 10A and API 10B-2.

The molded composition is cured for about 24 hours. The cured specimen has a destructive strength of about 1850 to about 2650 psi by following API 10A. The cured specimen has an ultrasonic compressive strength (UCS) of about 1750 to about 2150 psi by following API 10B-2 using an ultrasonic cement analyzer.

Certain embodiments of this disclosure can be implemented as methods of cementing oil and gas wells. The method includes mixing the cement sack composition and an aqueous solution to form a slurry. The slurry is placed into the oil and gas wells and allowing the slurry to set therein.

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “particle size” and “pore size” are thought of as the lengths or longest dimensions of a particle and of a pore opening, respectively.

As used herein, the terms “room temperature” or “ambient temperature” refer to a temperature in a range of 25 degrees Celsius (° C.)±3° C. in the present disclosure.

As used herein, the term or phrase “cement” refers to a composition or substance with one or more constituents that is capable of binding materials together, once set. Generally, cement may include a number of dry constituents chosen based on the desired ratio or class of cement to be produced. Thus, cement refers to the dry, pre-set composition unless the context clearly dictates otherwise, for example, in a wet cement slurry, or in a cured cement material. In one embodiment, the cement may include hydraulic cement, non-hydraulic cement, or a combination thereof. In one embodiment, the cement comprises Portland cement, a basic ingredient of concrete, mortar, stucco, and non-specialty grout, which is a fine powder, produced by heating limestone and clay minerals in a kiln to form clinker, grinding the clinker, and adding small amounts of other materials. Several types of Portland cement may be employed herein, for example, API Class A, Class C, Class G, or Class H; Ordinary Portland Cement (OPC) Type I, Type II, Type III, Type IV, or Type V; or a combination thereof (in accordance with the ASTM CI50 standard). Portland Cement Type Ia, Type IIa, and/or Type IIIa may also be used, which have the same composition as Types I, II, and III except that an air-entraining agent is ground into the mix (also in accord with the ASTM C150 standard).

As used herein, the term “Portland cement” refers to the most common type of cement in general use developed from types of hydraulic lime and usually originating from limestone. It is a fine powder produced by heating materials in a kiln to form what is called clinker, grinding the clinker, and adding small amounts of other materials. The Portland cement is made by heating limestone (calcium carbonate) with other materials (such as clay) to >1400° C. This process in a kiln is also known as calcination, whereby a molecule of carbon dioxide is liberated from the calcium carbonate to form calcium oxide, or quicklime, which is then blended with the other materials that have been included in the mix to from calcium silicates and other cementitious compounds. The resulting hard substance, called “clinker” is then ground with a small amount of gypsum into a powder to make ordinary Portland cement (OPC). Several types of Portland cement are available with the most common being called ordinary Portland cement (OPC) which is grey in color.

As used herein, a “dispersant” is an additive that increases the plasticity or fluidity of slurry. Dispersants increase the workability of cement sack compositions when formed to create a slurry, allowing it to be placed more easily, with less consolidating effort. A superplasticizer is a plasticizer with fewer deleterious effects. A “superplasticizer” refers a chemical admixture used herein to provide a well-dispersed particle suspension in the wet cement sack composition. The superplasticizer may be used to prevent particle segregation and to improve the flow characteristics of the wet cement sack composition.

As used herein, the term “deforming agent” refers to the chemical additive that reduces and hinders foam formation when creating a slurry.

As used herein, the term“retarder” refers to a chemical additive used in cementing operations to delay the setting time of cement.

As used herein, the term“fluid loss control agent” refers to a chemical additive used in oil well cementing and drilling fluids to reduce the loss of fluid into porous formations.

As used herein, the term“viscosity modifier” refers to a chemical additive used in adjusting the thickness or flow properties of a fluid. In oil well cementing and drilling, viscosity modifier helps control the rheology of slurries, ensuring proper placement, pumpability, and stability.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

We claim:

1. A cement sack composition, comprising:
a hydraulic cement selected from the group consisting of an API Class A Portland cement, an API Class C Portland cement, an API Class G Portland cement, an API Class H Portland cement, and combinations thereof; and
an additive in an amount of about 0.01 to about 50% by weight substitution of the hydraulic cement in the cement sack composition, wherein the additive is selected from the group consisting of fine grade marble, medium grade marble, coarse grade marble, and combinations thereof;
wherein a cured specimen made from the cement sack composition can meet or exceed one or more physical performance specifications as described in API 10A.

2. The cement sack composition of claim 1, comprising:
an API Class A Portland cement; and
about 1 to about 20% coarse grade marble by weight substitution of the API Class A Portland cement in the cement sack composition.

3. The cement sack composition of claim 1, comprising:
an API Class A Portland cement; and
about 0.01 to about 5% medium grade marble by weight substitution of the API Class A Portland cement in the cement sack composition.

4. The cement sack composition of claim 1, comprising:
an API Class C Portland cement; and
about 0.1 to about 15% coarse grade marble by weight substitution of the API Class C Portland cement in the cement sack composition.

5. The cement sack composition of claim 1, comprising:
an API Class C Portland cement; and
about 0.01 to about 5% medium grade marble by weight substitution of the API Class C Portland cement in the cement sack composition.

6. The cement sack composition of claim 1, comprising:
an API Class G Portland cement; and
about 0.01 to about 15% coarse grade marble by weight substitution of the API Class G Portland cement in the cement sack composition.

7. The cement sack composition of claim 1, comprising:
an API Class G Portland cement; and
about 0.01 to about 30% medium grade marble by weight substitution of the API Class G Portland cement in the cement sack composition.

8. The cement sack composition of claim 1, comprising:
an API Class G Portland cement; and
about 1 to about 40% fine grade marble by weight substitution of the API Class G Portland cement in the cement sack composition.

9. The cement sack composition of claim 1, comprising:
an API Class H Portland cement; and
about 0.01 to about 20% coarse grade marble by weight substitution of the API Class H Portland cement in the cement sack composition.

10. The cement sack composition of claim 1, comprising:
an API Class H Portland cement; and
about 0.01 to about 35% medium grade marble by weight substitution of the API Class H Portland cement in the cement sack composition.

11. The cement sack composition of claim 1, comprising:
an API Class H Portland cement; and
about 1 to about 45% fine grade marble by weight substitution of the API Class H Portland cement in the cement sack composition.

12. The cement sack composition of claim 1, wherein the fine grade marble is in the form of powders having a 10% cumulative particle size (D₁₀) of from about 1 to about 5 micrometers (μm), a 50% cumulative particle size (D₅₀) of from about 8 to about 32 μm, and a 90% cumulative particle size (D₉₀) of from about 32 to about 90 μm.

13. The cement sack composition of claim 1, wherein the medium grade marble is in the form of regular-shaped particles having a D₁₀ particle size of from about 5 to about 25 μm, a D₅₀ particle size of from about 100 to about 200 μm, a D₉₀ particle size of 250 to about 410 μm.

14. The cement sack composition of claim 1, wherein the coarse grade marble is in the form of irregular-shaped particles having a D₁₀ particle size of from about 100 to about 300 μm, a D₅₀ particle size of from about 350 to about 750 μm, a D₉₀ particle size of 600 to about 1100 μm.

15. The cement sack composition of claim 1, wherein the fine grade marble comprises:
about 87.1 to about 91.1 wt. % of dolomite (CaMg(CO₃)₂); and
about 8.9 to about 12.9 wt. % of calcite (CaCO₃), each wt. % based on a total weight of the fine grade marble.

16. The cement sack composition of claim 1, wherein the medium grade marble comprises:
about 91.7 to about 95.7 wt. % of dolomite; and
about 4.3 to about 8.3 wt. % of calcite, each wt. % based on a total weight of the medium grade marble.

17. The cement sack composition of claim 1, wherein the coarse grade marble comprises:
about 84 to about 88 wt. % of dolomite; and
about 12 to about 16 wt. % of calcite, each wt. % based on a total weight of the coarse grade marble.

18. A method of producing a cured specimen, the method comprising:
mixing the cement sack composition of claim 1 with an aqueous solution to form a slurry;
casting the slurry in a mold to form a molded composition; and
curing the molded composition to form the cured specimen by following API 10A and API 10B-2.

19. The method of claim 18, wherein the molded composition is cured for about 24 hours, and the cured specimen has a destructive strength of about 1850 to about 2650 psi by following API 10A, and an ultrasonic compressive strength (UCS) of about 1750 to about 2150 psi by following API 10B-2 using an ultrasonic cement analyzer.

20. A method of cementing oil and gas wells comprising:
mixing the cement sack composition of claim 1 and an aqueous solution to form a slurry; and
placing the slurry into the oil and gas wells and allowing the slurry to set therein.
